(19) United States
(12) Patent Application Publication
(10) Pub. No.: US 2023/0334427 A1
(43) Pub. Date: Oct. 19, 2023

(54) INFORMATION PROCESSING SYSTEM

(71) Applicant: bellFace Inc., Tokyo (JP)

(72) Inventors: Kazuaki NAKAJIMA, Kanagawa (JP); Koji INUI, Tokyo (JP); Tasuku ISHIDA, Tokyo (JP); Akihiro KOBAYASHI, Narashino-shi (JP)

(73) Assignee: bellFace Inc., Tokyo (JP)

(21) Appl. No.: 18/025,071

(22) PCT Filed: Oct. 22, 2021
(86) PCT No.: PCT/JP2021/039139

§ 371 Date: Mar. 7, 2023

(30) Foreign Application Priority Data
Oct. 28, 2020 (JP) 2020-180344
Oct. 28, 2020 (JP) 2020-180417
Oct. 28, 2020 (JP) 2020-180507

(51) Int. Cl. G06Q 10/1053; G06F 16/68

(52) U.S. Cl. CPC G06Q 10/1053; G06F 16/686

(57) ABSTRACT

One aspect of the present invention provides an information processing system. The information processing system includes a control unit. The control unit generates text data obtained by converting voice data relating to an interview with an interviewee into texts. Video data relating to the interview and the text data are stored in association with each other, as interview data, in a storage area. Multiple sets of interview data are searched based on search conditions including a word relating to an interviewee's request. Control is performed to output a search result screen including search results. The search result screen includes a category composition ratio obtained when the request is classified into categories.

### TECHNICAL FIELD

The present invention relates to an information processing system.

### BACKGROUND ART

There are online sales systems. Patent Literature 1 discloses a communication support device that enables communications by sharing a web page without incorporating dedicated software and applications.

Further, there are methods called inside sales in which sales activities are conducted remotely for interviewees. Patent Literature 2 discloses a prospective interviewee prediction device that is usable for inside sales.

### CITATION LIST

### Patent Literature

Patent Literature 1: Japanese Patent Application Laid-Open No. 2017-4499
Patent Literature 2: Japanese Patent No. 6031165

### SUMMARY OF INVENTION

### Technical Problem

Even if communication support devices for sales by a plurality of sales representatives are the same, there will be differences in sales performance. However, the conventional techniques are unable to reveal what kind of sales would make differences in performance.

Further, during interviews with interviewees, the interviewees may make requests. However, the conventional techniques are unable to comprehend what kind of requests are made by the interviewees during the interviews.

In addition, it is a problem that appropriate material cannot be quickly prepared and presented according to contents of talks during interviews.

### Solution to Problem

An aspect of the present invention provides an information processing system. This information processing system includes a control unit. The control unit controls an interview between an interview organizer and an interviewee over the Internet. After termination of the multiple interviews, in response to a display request, the control unit displays a communication index relating to an interview between a first interview organizer and an interviewee of the first interview organizer and a communication index relating to an interview between a second interview organizer and an interviewee of the second interview organizer, in a comparable manner.

An aspect of the present invention provides an information processing system. This information processing system includes a control unit. The control unit generates text data obtained by converting voice data relating to an interview with an interviewee into texts. Video data relating to the interview and the text data are stored in association with each other, as interview data, in a storage area. Multiple sets of interview data are searched based on search conditions including a word relating to an interviewee's request. Control is performed to output a search result screen including search results. The search result screen includes a category composition ratio obtained when the request is classified into categories.

An aspect of the present invention provides an information processing system. This information processing system includes a control unit. The control unit connects multiple users to an interview over the Internet, and receives voices of the multiple users during the interview. When a combination of keywords being set is detected from the received voices, the control unit outputs material relating to the combination of keywords, in a manner comprehensible to at least one of the multiple users.

### BRIEF DESCRIPTION OF DRAWINGS

FIG. 1 is a diagram illustrating an exemplary system configuration of an information processing system 1000.

FIG. 2 is a diagram illustrating an exemplary hardware configuration of a server device 100.

FIG. 3 is a diagram illustrating an exemplary hardware configuration of a PC 110.

FIG. 4 is a diagram illustrating an exemplary function configuration of the server device 100.

FIG. 5 is a diagram illustrating an exemplary screen during an interview, which is displayed on a screen of an interview organizer PC 110 by a display control unit 404.

FIG. 6 is a diagram (Part 1) illustrating an exemplary communication index display screen, which is displayed on a screen of a PC 130 by the display control unit 404.

FIG. 7 is a diagram (Part 2) illustrating an exemplary communication index display screen, which is displayed on the screen of the PC 130 by the display control unit 404.

FIG. 8 is a diagram (Part 3) illustrating an exemplary communication index display screen, which is displayed on the screen of the PC 130 by the display control unit 404.

FIG. 9 is a diagram (Part 4) illustrating an exemplary communication index display screen, which is displayed on the screen of the PC 130 by the display control unit 404.

FIG. 10 is an activity diagram illustrating exemplary information processing for displaying communication indices in the server device 100.

FIG. 11 is a diagram illustrating an exemplary communication index display screen, which is displayed on the screen of the PC 130 by the display control unit 404 of a modified example 1.

FIG. 12 is a diagram illustrating an exemplary system configuration of an information processing system.

FIG. 13 is a diagram illustrating an exemplary hardware configuration of a server device.

FIG. 14 is a diagram illustrating an exemplary hardware configuration of a client device.

FIG. 15 is a diagram illustrating an exemplary function configuration of the server device.

FIG. 16 is an activity diagram illustrating exemplary information processing relating to registration of interview data in the server device.

FIG. 17 is an activity diagram illustrating exemplary information processing relating to search in the server device.

FIG. 18 is a diagram illustrating an exemplary search result screen generated by an output control unit.

FIG. 19 is a diagram illustrating an exemplary system configuration of an information processing system.

FIG. 20 is a diagram illustrating an exemplary hardware configuration of a server device.

FIG. 21 is a diagram illustrating an exemplary hardware configuration of a client device.

FIG. 22 is a diagram illustrating an exemplary function configuration of the server device.

FIG. 23 is a diagram illustrating exemplary keyword combinations or the like set by a setting unit.

FIG. 24 is a diagram (Part 1) illustrating an exemplary interview screen on which material is displayed.

FIG. 25 is a diagram (Part 2) illustrating an exemplary interview screen on which material is displayed.

FIG. 26 is an activity diagram illustrating exemplary information processing relating to keyword setting in the server device.

FIG. 27 is an activity diagram illustrating exemplary information processing relating to output of material in the server device.

FIG. 28 is a diagram illustrating exemplary keyword combinations or the like set by a setting unit of a modified example 3.

FIG. 29 is a diagram (Part 3) illustrating an exemplary interview screen on which material is displayed.

FIG. 30 is a diagram (Part 4) illustrating an exemplary interview screen on which material is displayed.

FIG. 31 is a diagram illustrating exemplary keyword combinations set by a setting unit of a modified example 4.

FIG. 32 is a diagram illustrating exemplary keyword combinations set by a setting unit of a modified example 6.

### DESCRIPTION OF EMBODIMENTS

Hereinafter, embodiments of the present invention will be described with reference to attached drawings. Various feature items in the embodiments described below can be combined with each other.

By the way, programs for realizing software appearing in the present embodiment may be provided in the form of a computer-readable non-transitory recording medium, or may be provided so as to be downloadable from an external server. Alternatively, the programs may be provided in the form of being activated by an external computer so that a client terminal realizes a function thereof (so-called cloud computing).

Further, in the present embodiment, the terminology “unit” may include, for example, a combination of hardware resources implemented by circuits in a broad sense and software information processing that can be concretely realized by these hardware resources. In addition, the present embodiment handles various types of information, which are represented by, for example, physical values as signal values representing voltage or current, high and low of signal values as binary bit aggregates consisting of 0 or 1, or quantum superpositions (so-called quantum bits), and communications and operations can be executed on circuits in a broad sense.

Further, the circuit in a broad sense is a circuit that can be realized by appropriately combining at least some selected from the group consisting of circuits, circuitries, processors, memories, and the like. That is, examples of the circuit in abroad sense include an application specific integrated circuit (ASIC) and a programmable logic device (for example, a simple programmable logic device (SPLD), a complex programmable logic device (CPLD), and a field programmable gate array (FPGA)).

### Embodiment 1

1. System Configuration

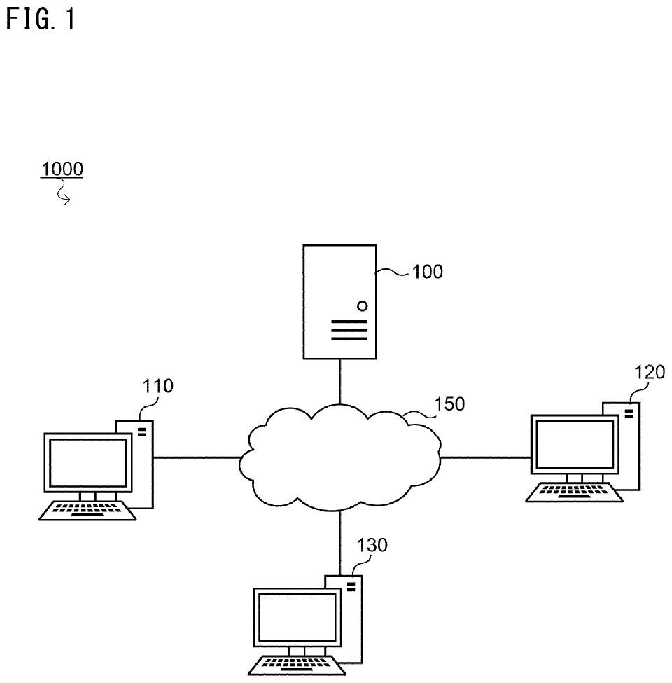

FIG. 1 is a diagram illustrating an exemplary system configuration of an information processing system 1000. The information processing system 1000 includes, as the system configuration, a server device 100, a PC 110, a PC 120, a PC 130, and a network 150. The PC 110 is a personal computer (PC) of an interview organizer. The PC 120 is a PC of an interviewee. The interview organizer is a person who has hosted an interview, and is referred to as a host side. The interviewee is a partner of the interview organizer in the interview, and is referred to as a guest side. The interview organizer copies URL of a Web conference and shares it with guests by e-mail or the like. The PC 130 is a PC that displays, after the interview has been conducted, interview-related recording data and communication indices, as described below.

When the interview is a business negotiation, the interview organizer is a sales representative and the interviewee is a customer in sales. When the interview is a job interview, the interview organizer is a person in charge of interviews at a company or the like that conducts interviews, and the interviewee is an applicant who is applying for recruitment of the company. The interviews are not limited the above-described examples and include those in which multiple users interact with each other by means of screens and voices over the Internet. Further, each of the interview organizer and the interviewee is not limited to one person.

The server device 100, the PC 110, and the PC 120 are connected via the network 150 so that they can communicate with each other.

Each information processing system in the claims may be configured by a plurality of devices (for example, by a server device and a PC, or by multiple server devices), or may be configured by a single device (for example, a server device).

The devices that are operated by the interview organizer and the interviewee are not limited to PCs, and may be smartphones, tablet PCs, wearable devices, and the like.

Voices during interviews in the information processing system 1000 of the present embodiment will be described as being performed using telephones, but the network 150 may be used for the same purpose.

2. Hardware Configuration

(1) Hardware Configuration of Server Device 100

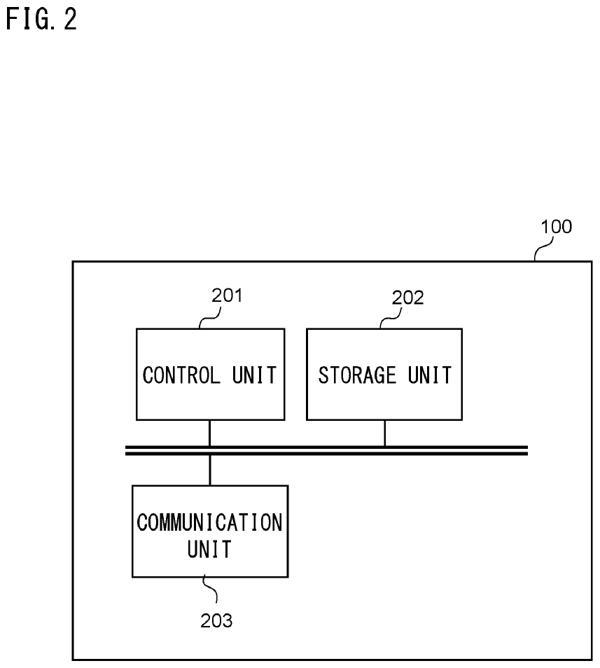

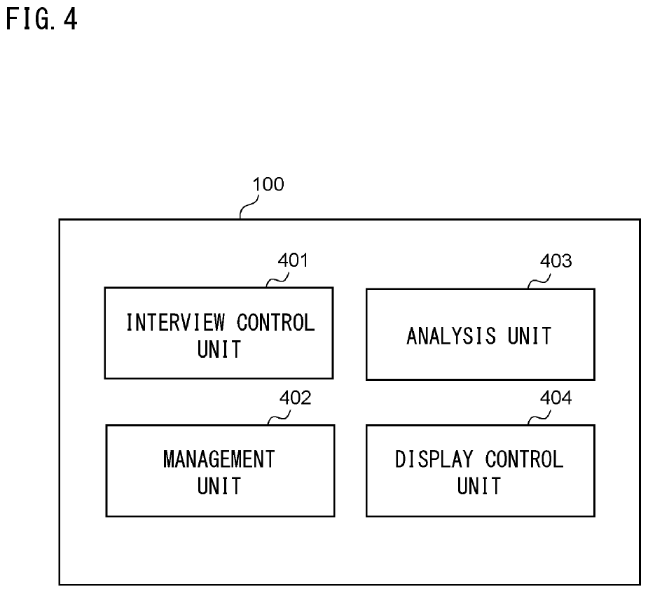

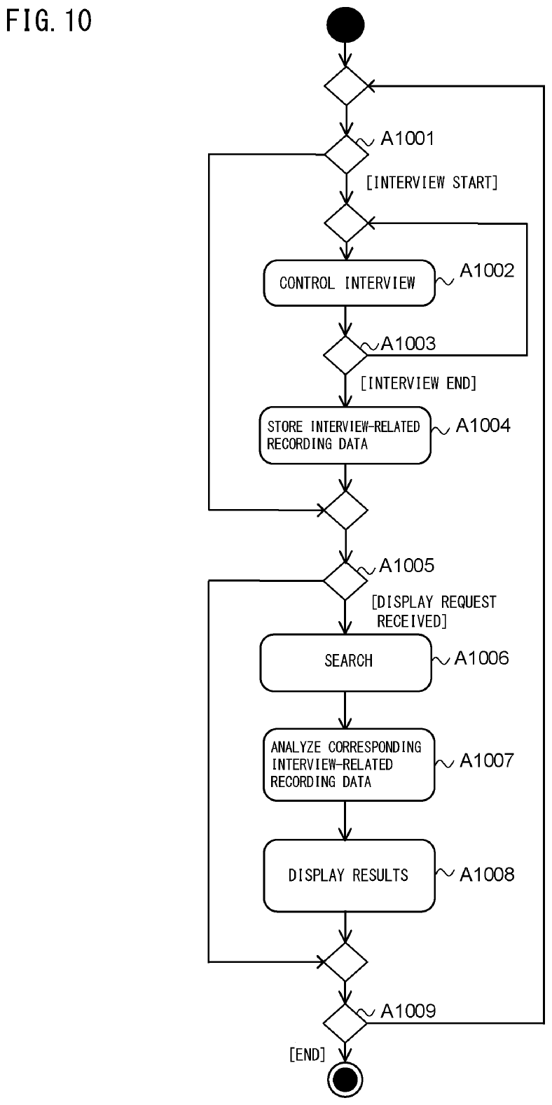

FIG. 2 is a diagram illustrating an exemplary hardware configuration of the server device 100. The server device 100 includes, as the hardware configuration, a control unit 201, a storage unit 202, and a communication unit 203. The control unit 201 entirely controls the server device 100. The storage unit 202 stores programs and data or the like to be used when the control unit 201 executes processing based on the programs. The control unit 201 executing processing based on the programs stored in the storage unit 202 can realize a function configuration described below with reference to FIG. 4 and also processing of an activity diagram described below with reference to FIG. 10. The communication unit 203 connects the server device 100 to the network 150 and controls communications with other devices. The storage unit 202 is an exemplary storage medium.

(2) Hardware Configuration of PC 110

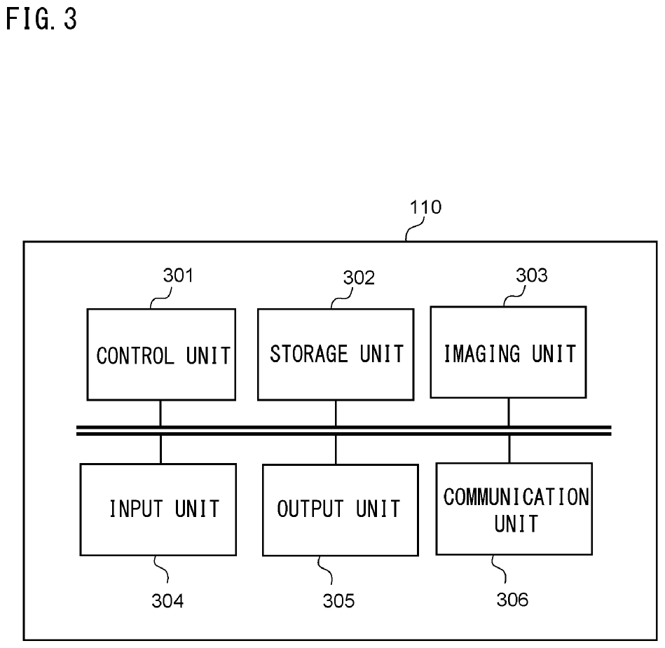

FIG. 3 is a diagram illustrating an exemplary hardware configuration of the PC 110. The PC 110 includes, as the hardware configuration, a control unit 301, a storage unit 302, an imaging unit 303, an input unit 304, an output unit 305, and a communication unit 306. The control unit 301 entirely controls the PC 110. The storage unit 302 stores programs and data or the like to be used when the control unit 301 executes processing based on the programs. The imaging unit 303 captures an image of a subject such as an operator of the PC 110. The input unit 304 inputs operator's operation information. The input operation information is received by the control unit 301. The output unit 305 displays data or the like under the control of the control unit 301. The communication unit 306 connects the PC 110 to the network 150 and controls communications with other devices.

Hardware configurations of the PC 120 and the PC 130 are similar to the hardware configuration of the PC 110.

3. Function Configuration

FIG. 4 is a diagram illustrating an exemplary function configuration of the server device 100. The server device 100 includes, as the function configuration, an interview control unit 401, a management unit 402, a display control unit 404, and an analysis unit 403.

The interview control unit 401 controls an interview between an interview organizer and an interviewee via the network 150. For example, the interview control unit 401 connects the interview organizer PC 110 to the interviewee PC 120 via the network 150, and controls reception and delivery or the like of interview-related image data and voice data. The network 150 is an example of the Internet.

The management unit 402 performs voice recognition on voices in interviews, and converts recognized voices into character strings. At this time, the management unit 402 classifies speakers (interview organizers and interviewees) in interviews based on voice waveforms or the like, and obtains character strings converted for respective speakers. As another example, the management unit 402 may analyze the converted character strings and classify the speakers in interviews based on analysis results. The management unit 402 stores, in the storage unit 202 or the like, speaker-separated character string data in interviews and videos in these interviews, in association with each other, as recording data relating to interviews. In addition, based on information from the interview control unit 401 and the display control unit 404, or the like, the management unit 402 acquires screen operation history, action time, number of actions, and the like, of the interview organizer side as well as screen operation history, action time, number of actions, and the like, of the interviewee side, during the interview, and manages them together with the recording data relating to interviews. Further, based on information from the interview control unit 401 and the display control unit 404, or the like, if the interviewee is looking at a screen other than the one explained by the interview organizer during an online interview, the management unit 402 acquires information about which screen the interviewee is looking at, and manages the acquired information together with the recording data relating to interviews. Moreover, the management unit 402 stores, in the storage unit 202, the interview-related recording data by adding date of the interview conducted, information about the interview organizer, information about the interviewee, information indicating whether the interview was one-to-one, one-to-many, or many-to-many, and the like.

The display control unit 404 controls screen display relating to interviews between interview organizers and interviewees via the network 150. More specifically, the display control unit 404 controls display of live video, display of material, display of Web site, display of minute book, synchronous display of material, or the like. Further, the display control unit 404 not only controls the screen display during the interview for the PC 110 and the PC 120 but also controls the screen display or the like of search results obtained based on a search key from interview-related recording data of multiple interviews after the interviews.

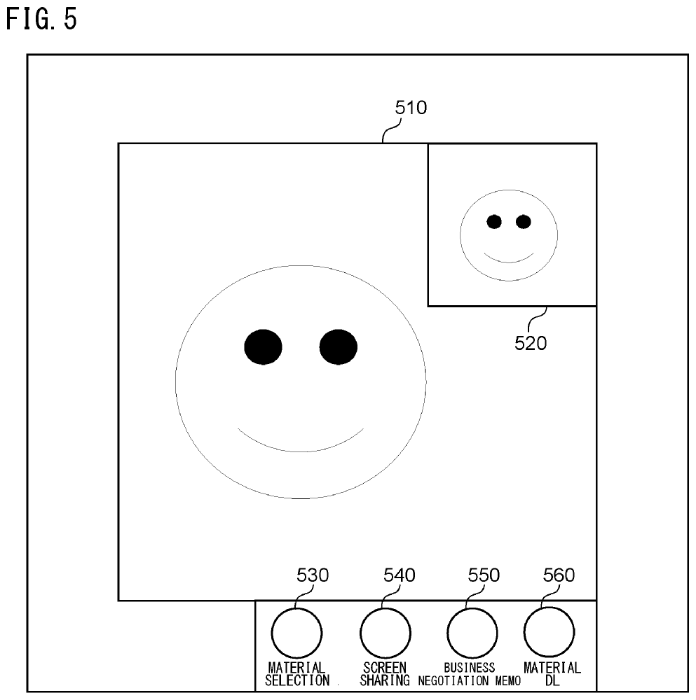

FIG. 5 is a diagram illustrating an exemplary screen during an interview, which is displayed on the screen of the interview organizer PC 110 by the display control unit 404. A live video of an interviewee is displayed in an area 510. A live video of an interview organizer is displayed in an area 520. When a material selection button 530 is selected, the display control unit 404 displays a window (screen) for selecting the material, and in response to selection of the material via the screen and a predetermined operation performed, displays the material on the screen of the interviewee PC 120 and the screen of the interview organizer PC 110, in synchronism with each other. When a screen sharing button 540 is selected, the display control unit 404 performs control to display the screen of the interview organizer PC 110 directly on the interviewee PC 120. When a business negotiation memo button 550 is selected, the display control unit 404 displays a window (screen) that enables taking a memo during a business negotiation on the output unit 305 of the interview organizer PC 110. When a material download button 560 is selected, the display control unit 404 displays a window (screen) that enables selecting the material to be downloaded, and in response to selection of material via the screen and a predetermined operation performed, downloads the material to the PC 110.

Further, after termination of multiple interviews, the display control unit 404 displays, in response to a display request, a communication index relating to an interview between a first business negotiation host and a business negotiation partner of the first business negotiation host and a communication index relating to an interview between a second business negotiation host and a business negotiation partner of the second business negotiation host, in a comparable manner. More specifically, the analysis unit 403 acquires, in response to a request from the display control unit 404, corresponding multiple sets of first data relating to the business negotiation between the first business negotiation host and the business negotiation partner of the first business negotiation host and multiple sets of second data relating to the business negotiation between the second business negotiation host and the business negotiation partner of the second business negotiation host, from the storage unit 202. Then, the analysis unit 403 obtains, based on the multiple sets of first data and the multiple sets of second data having been acquired, the communication index between the first business negotiation host and the business negotiation partner of the first business negotiation host and the communication index between the second business negotiation host and the business negotiation partner of the second business negotiation host. Then, the display control unit 404 displays the communication index between the first business negotiation host and the business negotiation partner of the first business negotiation host and the communication index between the second business negotiation host and the business negotiation partner of the second business negotiation host, in a comparable manner.

The first data includes sound recording data relating to the business negotiation between the first business negotiation host and the business negotiation partner of the first business negotiation host. The second data includes sound recording data relating to the business negotiation between the second business negotiation host and the business negotiation partner of the second business negotiation host. The first data includes video recording data relating to the business negotiation between the first business negotiation host and the business negotiation partner of the first business negotiation host. The second data includes video recording data relating to the business negotiation between the second business negotiation host and the business negotiation partner of the second business negotiation host. The first data includes screen operation data during the business negotiation between the first business negotiation host and the business negotiation partner of the first business negotiation host. The second data includes screen operation data during the business negotiation between the second business negotiation host and the business negotiation partner of the second business negotiation host. The interview-related recording data is examples of the first data and the second data.

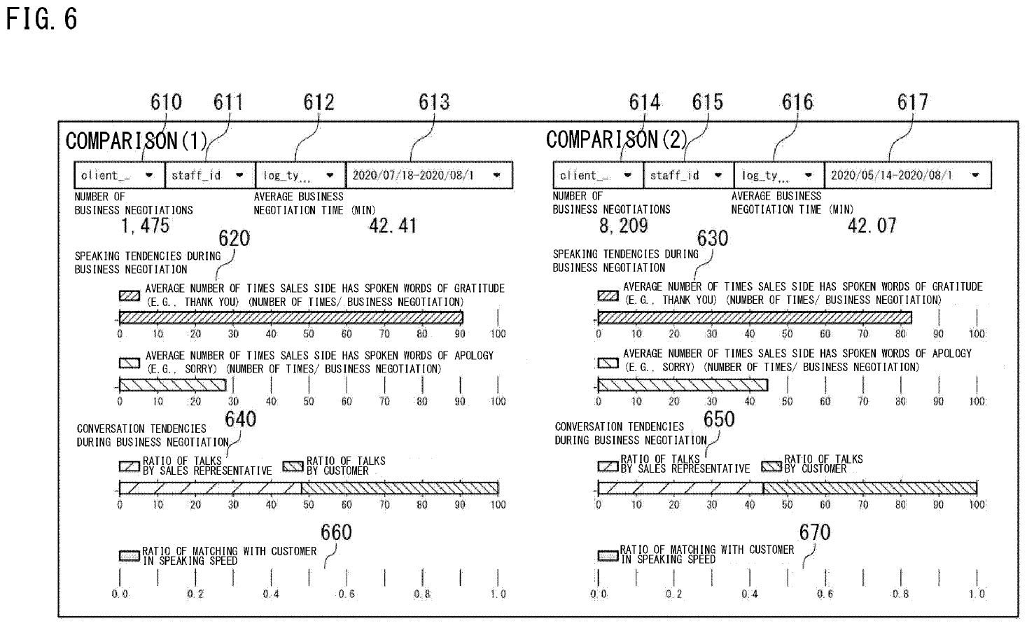

FIG. 6 is a diagram (Part 1) illustrating an exemplary communication index display screen, which is displayed on the screen of the PC 130 by the display control unit 404. A selection area 610 and a selection area 614 are areas for selecting the interviewee of an interview to be searched. A selection area 611 and a selection area 615 are areas for selecting the name of an interview organizer of an interview to be searched. It is possible to select multiple interview organizers in the selection area 611 and the selection area 615. A selection area 612 and a selection area 616 are areas for selecting the type of an interview (one-to-one interview, one-to-many interview, or the like) to be searched. A selection area 613 and a selection area 617 are areas for selecting the date/time of an interview to be searched.

When search object information is selected in the selection area 610 to the selection area 613 and a predetermined operation is performed, the display control unit 404 searches interview-related recording data based on the selected information and displays search results. When FIG. 6 is used as an example for explanation, the search results of the search object information selected in the selection area 610 to the selection area 613 are displayed in an area 620, an area 640, and an area 660 in the left side of FIG. 6. Similarly, when search object information is selected in the selection area 614 to the selection area 617 and a predetermined operation is performed, the display control unit 404 searches interview-related recording data based on the selected information and displays search results. When FIG. 6 is used as an example for explanation, the search results of the search object information selected in the selection area 614 to the selection area 617 are displayed in an area 630, an area 650, and an area 670 in the right side of FIG. 6. In the present embodiment, for the purpose of simplifying the description, exemplary screens are separately displayed in FIG. 6 to FIG. 9, but these screens may be a single screen. That is, the search results of the search object information selected in the selection area 610 to the selection area 613 are displayed in left sides of respective screens illustrated in FIG. 6 to FIG. 9. The search results of the search object information selected in the selection area 614 to the selection area 617 are displayed in right sides of respective screens illustrated in FIG. 6 to FIG. 9.

For example, performing the search by selecting in the selection area 611 an interview organizer with the best sales performance in the company and selecting in the selection area 615 an interview organizer with below-average sales performance in the company makes it possible to confirm how communications during the interview are different between a staff with good sales performance and a staff with poor sales performance.

In response to selection of the search conditions in the selection area 610 to the selection area 613, the analysis unit 403 analyzes the interview-related recording data corresponding to the search conditions, which is managed by the management unit 402, and obtains communication indices relating to the interview organizer and the interviewee. The communication indices include, for example, information on a speaking tendency during the interview, information on a conversation tendency during the interview, information on a use situation of the material used in the interview, information on behavior of the interviewee in interview, the amount of money spoken by the interviewer during the interview, the number of speaking times, or the like.

The analysis unit 403 analyzes the interview-related recording data corresponding to the search conditions, and obtains the speaking tendencies during the interview. For example, the analysis unit 403 obtains, based on the interview-related recording data, the number of times the interview organizer has spoken a designated word, per interview, as the information on speaking tendencies during the interview. Examples of the designated word include “Thank you”, “Sony”, or the like. The display control unit 404 displays the information on speaking tendencies during the interview in the area 620, as analysis results obtained by the analysis unit 403. More specifically, the display control unit 404 displays the average number of times the interview organizer side has used words of gratitude during the interview and the average number of times the interview organizer side has used words of apology during the interview, respectively.

Further, the analysis unit 403 analyzes the interview-related recording data corresponding to the search conditions and obtains the conversation tendencies during the interview. For example, the analysis unit 403 obtains, as the information on conversation tendencies during the interview, the ratio of talks by the interview organizer and the ratio of talks by the interviewee, based on the interview-related recording data corresponding to the search conditions. The display control unit 404 displays, in the area 640, the information on conversation tendencies during the interview, as analysis results obtained by the analysis unit 403. More specifically, the display control unit 404 displays, in the area 640, the ratio of talks by the interview organizer and the ratio of talks by the interviewee, during the interview, respectively.

Further, the analysis unit 403 obtains, based on the interview-related recording data corresponding to the search conditions, the speaking speed of the interview organizer and the speaking speed of the interviewee, and obtains the ratio of matching with the interviewee in speaking speed, per interview, as information on conversation tendencies during the interview. Here, the analysis unit 403 obtains the speaking speed based on the number of characters relating to talks per minute. The display control unit 404 displays the ratio of matching with the interviewee in speaking speed, in the area 660, as analysis results obtained by the analysis unit 403.

The same is applied when search conditions are selected in the selection area 614 to the selection area 617. That is, the average number of times the interview organizer side has used words of gratitude during the interview and the average number of times the interview organizer side has used words of apology during the interview, which have been analyzed based on the recording data corresponding to the search conditions, are displayed respectively in the area 630. Further, the ratio of talks by the interview organizer and the ratio of talks by the interviewee, during the interview, which have been analyzed based on the recording data corresponding to the search conditions, are displayed respectively in the area 650. Further, the ratio of matching with the interviewee in speaking speed, which has been analyzed based on the recording data corresponding to the search conditions, is displayed in the area 670.

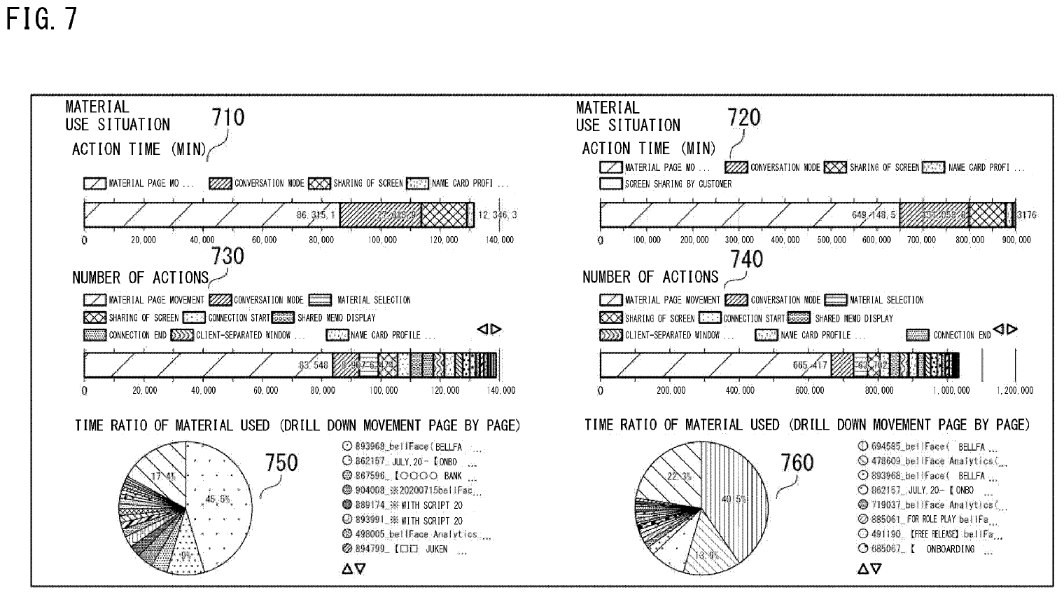

FIG. 7 is a diagram (Part 2) illustrating an exemplary communication index display screen, which is displayed on the screen of the PC 130 by the display control unit 404.

If search conditions are selected in the selection area 610 to the selection area 613, the analysis unit 403 analyzes the interview-related recording data corresponding to the search conditions and obtains the material use situation during the interview. For example, based on the interview-related recording data, the analysis unit 403 obtains time to move between material pages, time in conversation mode, time for screen sharing, time to display name card profiles, or the like, as information on a use situation of the material used in the interview. The display control unit 404 displays the information on a use situation of the material used in the interview, in an area 710, as analysis results obtained by the analysis unit 403. More specifically, the display control unit 404 displays the action time, such as time to move between material pages, time in conversation mode, time for screen sharing, and time to display name card profiles, in the area 710.

Further, based on the interview-related recording data corresponding to the search conditions, the analysis unit 403 obtains the number of times of movement between material pages, the number of times of conversation mode, the number of times of material selection, the number of times of screen sharing, the number of times of name card profile display, the number of times of shared memo display, the number of times of client-separated window display, the number of times of material download guidance display, the number of times of material download, the number of times of shared memo download guidance display, the number of times of shared memo download execution, or the like, as the information on a use situation of the material used in the interview. The display control unit 404 displays the information on a use situation of the material used in the interview, in an area 730, as analysis results obtained by the analysis unit 403. More specifically, the display control unit 404 displays the number of actions such as the number of times of movement between material pages, the number of times of conversation mode, the number of times of material selection, the number of times of screen sharing, the number of times of name card profile display, the number of times of shared memo display, the number of times of client-separated window display, the number of times of material download guidance display, the number of times of material download, the number of times of shared memo download guidance display, and the number of times of shared memo download execution, in the area 730.

Further, based on the interview-related recording data corresponding to the search conditions, the analysis unit 403 obtains a time ratio of the material used in the interview, as information on a use situation of the material used in the interview. The display control unit 404 displays the information on a use situation of the material used in the interview, in an area 750, as analysis results obtained by the analysis unit 403. More specifically, the display control unit 404 displays a pie graph indicating the time ratio of the material used in the interview, in the area 750.

The same is applied when search conditions are selected in the selection area 614 to the selection area 617. That is, the action time such as time to move between material pages, time in conversation mode, time for screen sharing, and time to display name card profiles, which have been analyzed based on the recording data corresponding to the search conditions, are displayed in an area 720. Further, the number of actions such as the number of times of movement between material pages, the number of times of conversation mode, the number of times of material selection, the number of times of screen sharing, the number of times of name card profile display, the number of times of shared memo display, the number of times of client-separated window display, the number of times of material download guidance display, the number of times of material download, the number of times of shared memo download guidance display, and the number of times of shared memo download execution, which have been analyzed based on the recording data corresponding to the search conditions, are displayed in an area 740. Further, a pie graph indicating the time ratio of the material used in the interview, which has been analyzed based on the recording data corresponding to the search conditions, is displayed in an area 760.

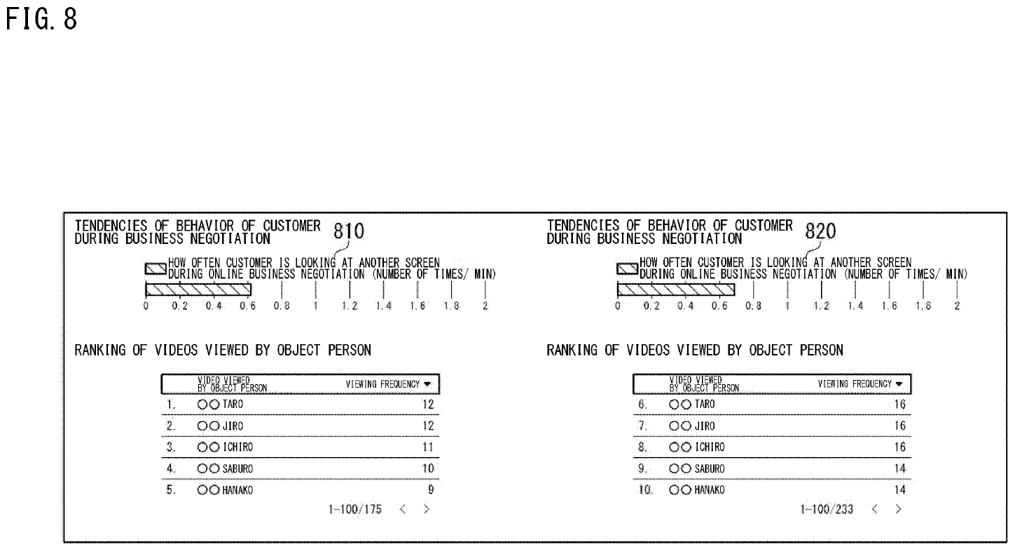

FIG. 8 is a diagram (Part 3) illustrating an exemplary communication index display screen, which is displayed on the screen of the PC 130 by the display control unit 404.

When search conditions are selected in the selection area 610 to the selection area 613, the analysis unit 403 analyzes the interview-related recording data corresponding to the search conditions and obtains tendencies of behavior of the interviewee during the interview. For example, based on the interview-related recording data corresponding to the search conditions, the analysis unit 403 obtains how often the interviewee is looking at another screen during an online interview, as information on the tendencies of behavior of the interviewee during the interview. Examples of another screen include, for example, a screen that the interview organizer is explaining and a screen shared by the interview organizer. The display control unit 404 displays, in an area 810, the information on tendencies of behavior of the interviewee during the interview, as analysis results obtained by the analysis unit 403. More specifically, the display control unit 404 displays, in the area 810, how often the interviewee is looking at another screen during an online interview.

The same is applied when search conditions are selected in the selection area 614 to the selection area 617. That is, how often the interviewee is looking at another screen during an online interview, which has been analyzed based on the recording data corresponding to the search conditions, is displayed in an area 820.

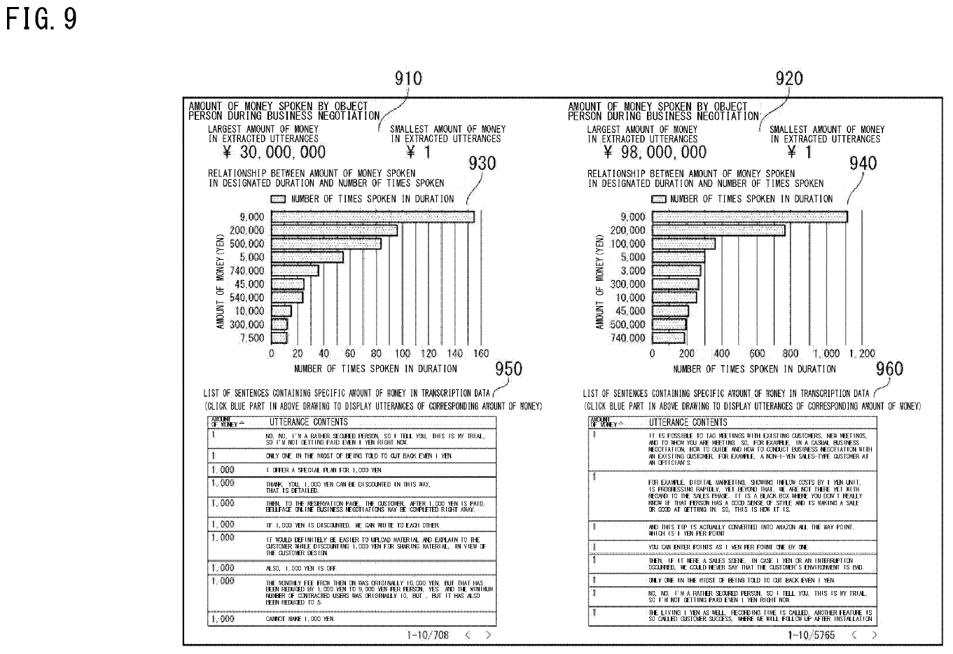

FIG. 9 is a diagram (Part 4) illustrating an exemplary communication index display screen, which is displayed on the screen of the PC 130 by the display control unit 404. When search conditions are selected in the selection area 610 to the selection area 613, the analysis unit 403 analyzes utterances of the interview-related recording data converted into character strings, which correspond to the search conditions, and obtains the amount of money spoken by an object person during the interview, the number of times of the amount of money spoken, and before-and-after utterance contents including the amount of money, or the like, as information on the amount of money spoken by the object person during the interview. The display control unit 404 displays the largest amount of money and the smallest amount of money in the extracted utterances, in an area 910, as analysis results obtained by the analysis unit 403. Further, the display control unit 404 displays a bar graph indicating the amount of money spoken in a designated duration and the number of times the amount of money has been spoken, in an area 930, as analysis results obtained by the analysis unit 403. Further, the display control unit 404 displays a list indicating sentences containing a specific amount of money, of the interview-related recording data converted into character strings, in an area 950, as analysis results obtained by the analysis unit 403. In this case, the display control unit 404 displays the bar graph displayed in the area 930 and the sentences displayed in the area 950, in association with each other. More specifically, when a relevant portion of the bar graph in the area 930 is selected, an utterance portion corresponding to this amount of money is highlighted in the area 950. Examples of the highlighted display include enlarging the font of characters in the relevant portion, differentiating the color for displaying characters in the relevant portion from that of other characters, or the like.

The same is applied when search conditions are selected in the selection area 614 to the selection area 617. That is, the largest amount of money and the smallest amount of money in utterances, which have been analyzed based on the recording data corresponding to the search conditions, are displayed in an area 920. Further, a bar graph indicating the amount of money spoken in a designated duration and the number of times the amount of money has been spoken, which have been analyzed based on the recording data corresponding to the search conditions, is displayed in an area 940. Further, a list of sentences containing a specific amount of money, of the interview-related recording data converted into character strings, which has been analyzed based on the recording data corresponding to the search conditions, is displayed in an area 960.

4. Information Processing

FIG. 10 is an activity diagram illustrating exemplary information processing for displaying communication indices in the server device 100.

In A1001, the interview control unit 401 determines whether an interview starts. For example, when predetermined operations have been performed in the PC 110 and the PC 120, the interview control unit 401 determines that the interview starts. If the interview control unit 401 determines that the interview starts, the processing proceeds to A1002. If the interview control unit 401 determines that the interview does not start, the processing proceeds to A1005.

In A1002, the interview control unit 401 controls the interview between the interview organizer using the PC 110 and the interviewee using the PC 120.

In A1003, the interview control unit 401 determines whether to terminate the interview. For example, when a predetermined operation has been performed in the PC 110, the interview control unit 401 determines to terminate the interview. If the interview control unit 401 determines to terminate the interview, the processing proceeds to A1004. If the interview control unit 401 determines not to terminate the interview, the processing returns to A1002.

In A1004, the management unit 402 stores interview-related recording data in the storage unit 202 or the like. As described above, the interview-related recording data includes speaker-separated character string data in the interview, videos in the interview, screen operation history of the interview organizer side in the interview, action time of the interview organizer side, the number of actions by the interview organizer side, screen operation history of the interviewee side, information indicating which screen on the interview organizer side is operated, action time of the interviewee side, the number of actions by the interviewee side, information indicating which screen on the interviewee side is operated, date of the interview conducted, information about the interview organizer, information about the interviewee, information indicating whether the interview was one-to-one, one-to-many, or many-to-many, and the like.

In A1005, the display control unit 404 determines whether a display request to display search results of the recording data has been received. For example, when search conditions are selected in the selection area 610 to the selection area 617 in the screen illustrated in FIG. 6, the display control unit 404 determines that the display request has been received. If the display control unit 404 determines that the display request has been received, the processing proceeds to A1006. If the display control unit 404 determines that the display request has not been received, the processing returns to A1001.

In A1006, the display control unit 404 searches interview-related recording data based on the search conditions selected via the screen.

In A1007, the analysis unit 403 analyzes the interview-related recording data acquired as search results.

In A1008, the display control unit 404 displays analysis results on the output unit of the corresponding PC (for example, PC 130), on which a search request has been selected, as illustrated in FIG. 6 to FIG. 9.

In A1009, the display control unit 404 determines whether to terminate the information processing for displaying communication indices illustrated in FIG. 10. If it is determined to terminate the information processing for displaying communication indices, the display control unit 404 terminates the processing illustrated in FIG. 10. If the display control unit 404 determines not to terminate the information processing for displaying communication indices, the processing returns to A1001.

According to the processing of the present embodiment, since the communication indices with respect to the interviewee can be obtained and output so that multiple users can be compared, it is possible to comprehend what causes differences in sales performance or the like. In addition, since communication methods or the like of personnel with good sales performance or the like can be learned, it can also be used to educate inexperienced personnel and those with poor sales performance.

### Modified Example

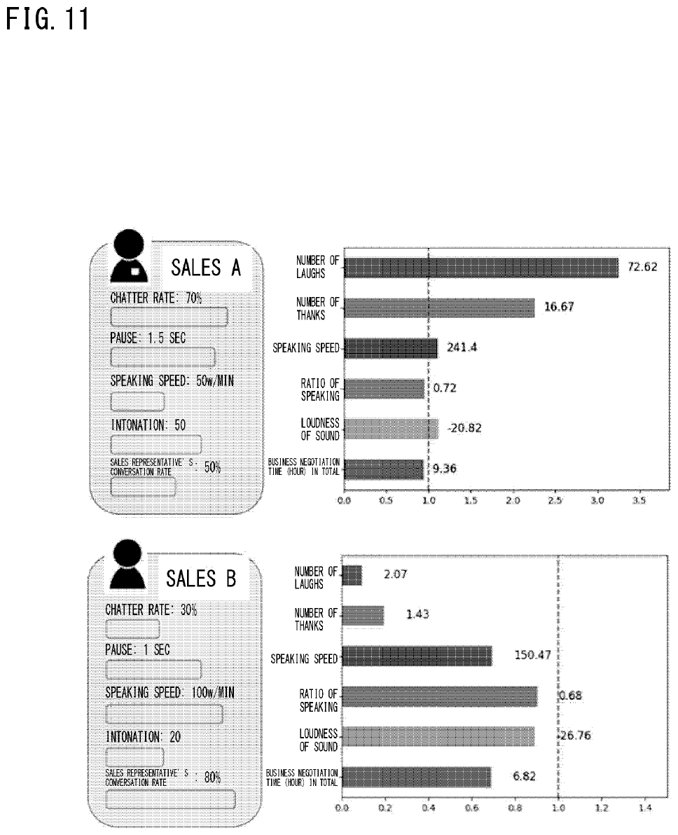

FIG. 11 is a diagram illustrating an exemplary communication index display screen, which is displayed on the screen of the PC 130 by the display control unit 404 of a modified example 1. The communication index display screens are not limited to the examples illustrated in FIGS. 6 to 9, and may be the one illustrated in FIG. 11. The display control unit 404 displays the communication indices of each selected personnel, in a comparable manner. In the example of FIG. 11, the server device 100 analyzes and displays the chatter rate, pause, speaking speed, intonation, and conversation rate, in the interview, as communication indices.

According to the modified example, since the communication indices with respect to the interviewee can be obtained and output so that multiple users can be compared, it is possible to comprehend what causes differences in sales performance or the like. In addition, since communication methods or the like of personnel with good sales performance or the like can be learned, it can also be used to educate inexperienced personnel and those with poor sales performance

<Supplementary Note>

The invention may be provided in each of the following aspects.

In the information processing system, the communication index includes information on a speaking tendency during the interview.

In the information processing system, the communication index includes information on a conversation tendency during the interview.

In the information processing system, the communication index includes information on a use situation of material used in the interview.

In the information processing system, the communication index includes information on behavior of the interviewee in the interview.

In the information processing system, the communication index includes an amount of money spoken by the interviewer during the interview and the number of speaking times.

In the information processing system, the control unit acquires first data relating to the interview between the first interview organizer and the interviewee of the first interview organizer, and second data relating to the interview between the second interview organizer and the interviewee of the second interview organizer, and displays, in response to a display request, based on the first data and the second data, the communication index between the first interview organizer and the interviewee of the first interview organizer and the communication index between the second interview organizer and the interviewee of the second interview organizer, in a comparable manner. In the information processing system, the first data includes sound recording data relating to the interview between the first interview organizer and the interviewee of the first interview organizer, and the second data includes sound recording data relating to the interview between the second interview organizer and the interviewee of the second interview organizer.

In the information processing system, the first data includes video recording data relating to the interview between the first interview organizer and the interviewee of the first interview organizer, and the second data includes video recording data relating to the interview between the second interview organizer and the interviewee of the second interview organizer.

In the information processing system, the first data includes screen operation data during the interview between the first interview organizer and the interviewee of the first interview organizer, and the second data includes screen operation data during the interview between the second interview organizer and the interviewee of the second interview organizer.

An information processing method to be executed by an information processing system includes a first step and a second step, the first step is controlling an interview between an interview organizer and an interviewee over the Internet, and the second step is displaying, after termination of the multiple interviews, in response to a display request, a communication index relating to an interview between a first interview organizer and an interviewee of the first interview organizer and a communication index relating to an interview between a second interview organizer and an interviewee of the second interview organizer, in a comparable manner.

A program causes a computer to function as a control unit of the information processing system.

It is needless to say that the invention is not limited to the above.

For example, a computer-readable non-transitory storage medium storing the above-described programs may be provided.

Further, an arbitrary combination of the above-described embodiments and modified examples may be implemented.

### Embodiment 2

1. System Configuration

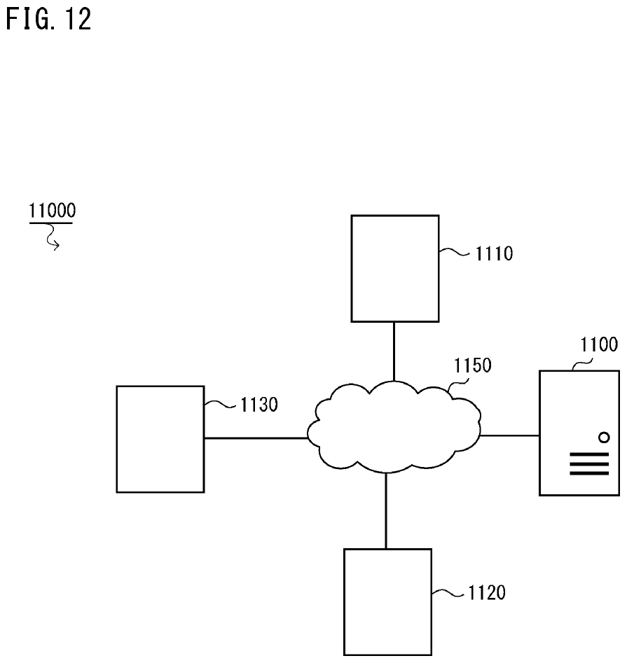

FIG. 12 is a diagram illustrating an exemplary system configuration of an information processing system 11000. As illustrated in FIG. 12, the information processing system 11000 includes, as the system configuration, a server device 1100, a client device 1110, a client device 1120, and a client device 1130. The client device 1110 is a personal computer (PC) or the like of an interview organizer. The client device 1120 is a PC or the like of an interviewee. The interview organizer is a person who has hosted an interview, and is referred to as a host side. The interviewee is a partner of the interview organizer in the interview, and is referred to as a guest side. The host side or the guest side accesses, for example, a predetermined URL to conduct a Web conference over the Internet. For example, the interview organizer copies the URL of the Web conference and shares it with guests by e-mail or the like. The client device 1130 is a PC or the like of a colleague or a superior of the interview organizer or the like.

When the interview is a business negotiation, the interview organizer is a sales representative and the interviewee is a customer in sales. When the interview is a recruiting interview, the interview organizer is a person in charge of interviews at a company or the like that conducts recruiting interviews, and the interviewee is an applicant who is applying for recruitment of the company. The interviews are not limited to the above-described examples and include those in which multiple users interact with each other by means of screens and voices over the Internet. Further, each of the interview organizer and the interviewee is not limited to one person.

The server device 1100, the client device 1110, the client device 1120, and the client device 1130 are connected by a network 1150 so that they can communicate with each other.

For the purpose of simplifying the description, FIG. 12 illustrates the information processing system 11000 including only one client device 1110, only one client device 1120, and only one client device 1130. However, each constituent of the information processing system 11000 may be configured by two or more devices. Further, the client device is not limited to a PC and may be a smartphone, a tablet computer, or the like. When an interview is conducted in the information processing system 11000, images and the like are exchanged over the Internet and voices are exchanged via a telephone network, but they are not limited to these examples.

Each information processing system described in the claims may be configured by multiple devices (for example, by the server device and the client device, or by multiple server devices) and also may be configured by a single device (for example, by the server device).

2. Hardware Configuration

(1) Hardware Configuration of Server Device 1100

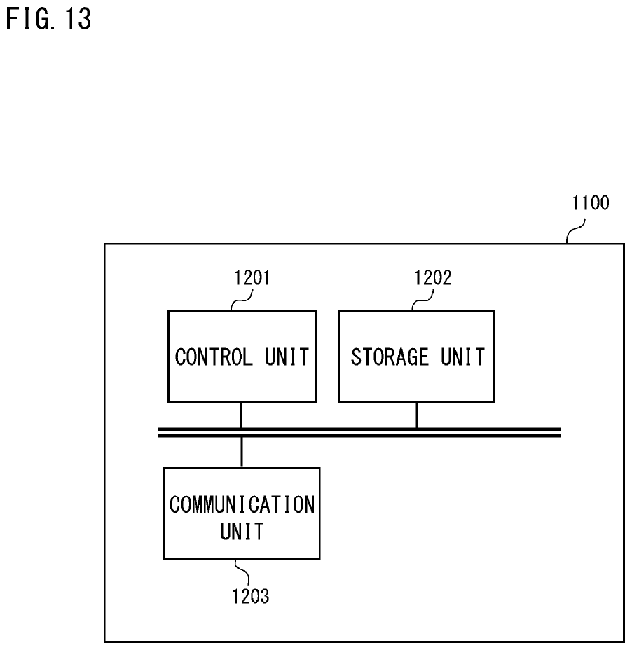

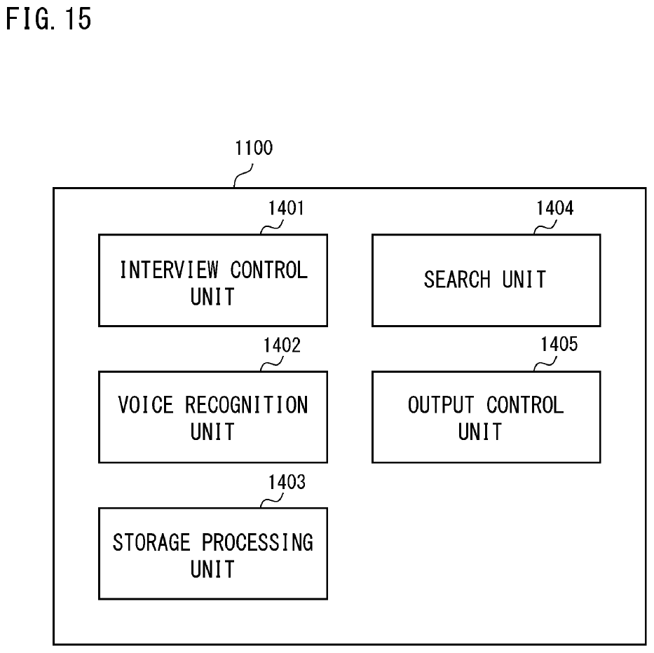

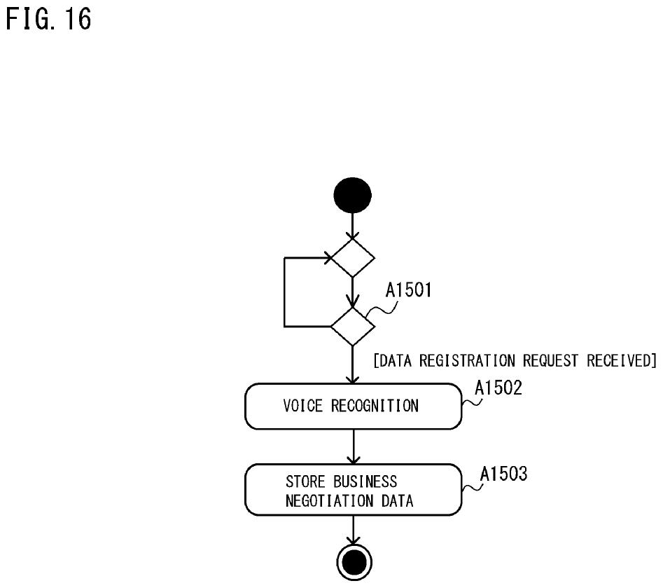

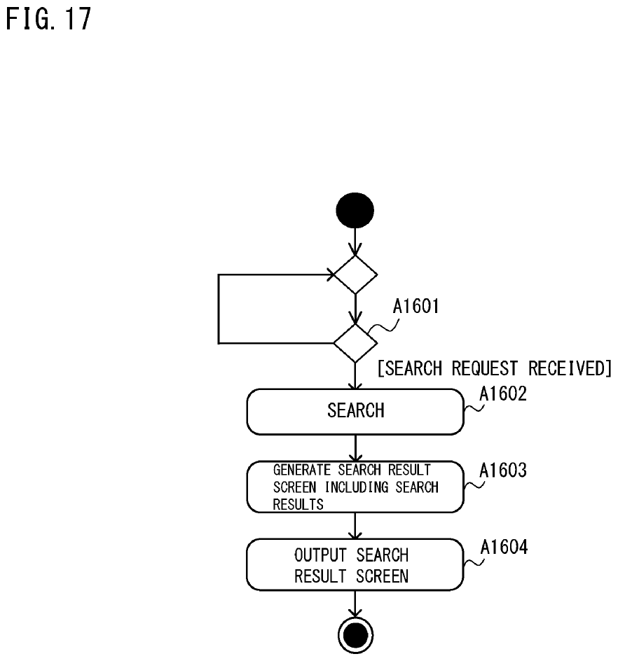

FIG. 13 is a diagram illustrating an exemplary hardware configuration of the server device 1100. The server device 1100 includes, as the hardware configuration, a control unit 1201, a storage unit 1202, and a communication unit 1203. The control unit 1201 is a central processing unit (CPU) or the like, which entirely controls the server device 1100. The storage unit 1202 is a hard disk drive (HDD), a read only memory (ROM), a random access memory (RAM) or the like, which stores programs and data or the like to be used when the control unit 1201 executes processing based on the programs. The control unit 1201 executing processing based on the programs stored in the storage unit 1202 can realize a function configuration of the server device 1100 described below with reference to FIG. 15 and processing of activity diagrams described below with reference to FIGS. 16 and 17. The communication unit 1203 is a network interface card (NIC) or the like, which connects the server device 1100 to the network 1150 and controls communications with other devices (for example, the client device 1130 and the like). The storage unit 1202 is an exemplary storage medium.

(2) Hardware Configuration of Client Device 1110

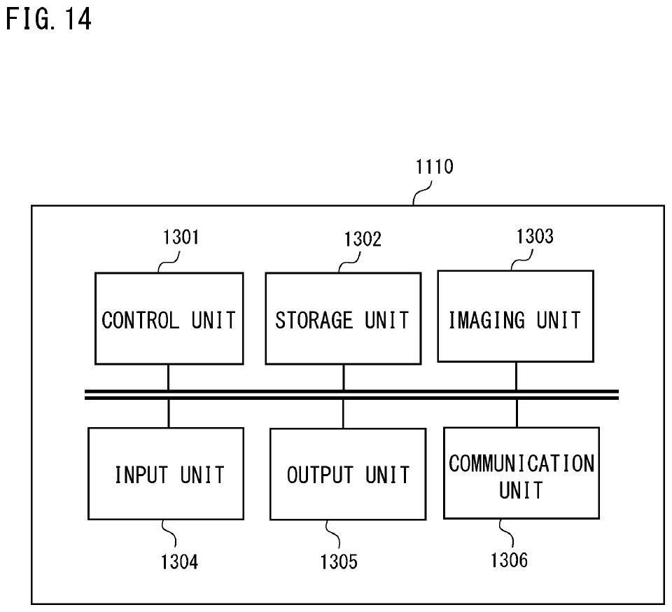

FIG. 14 is a diagram illustrating an exemplary hardware configuration of the client device 1110. The client device 1110 includes, as the hardware configuration, a control unit 1301, a storage unit 1302, an imaging unit 1303, an input unit 1304, an output unit 1305, and a communication unit 1306. The control unit 1301 is a CPU or the like, which entirely controls the client device 1110. The storage unit 1302 is a HDD, a ROM, a RAM or the like, which stores programs and data or the like to be used when the control unit 1301 executes processing based on the programs. The control unit 1301 executing processing based on the programs stored in the storage unit 1302 can realize functions of the client device 1110. The imaging unit 1303 is a camera or the like and captures an image of a user of the client device 1110. Examples of the input unit 1304 include a mouse and a keyboard, which input user operations to the control unit 1301. Another example of the input unit 1304 is a microphone or the like which inputs user voices to the control unit 1301. Examples of the output unit 1305 include a display device and a speaker, which output processing results or the like by the control unit 1201 by display or voice. The communication unit 1306 is a NIC or the like, which connects the client device 1110 to the network 1150 and controls communications with other devices (for example, the client device 1120 and the like).

Hardware configurations of the client device 1120 and the client device 1130 may be similar to the hardware configuration of the client device 1110. The control unit of the client device 1120 executing processing based on the programs stored in the storage unit of the client device 1120 can realize functions of the client device 1120. Similarly, the control unit of the client device 1130 executing processing based on the programs stored in the storage unit of the client device 1130 can realize functions of the client device 1130.

3. Function Configuration

FIG. 15 is a diagram illustrating an exemplary function configuration of the server device 1100. As illustrated in FIG. 15, the server device 1100 includes, as the function configuration, an interview control unit 1401, a voice recognition unit 1402, a storage processing unit 1403, a search unit 1404, and an output control unit 1405.

(Interview Control Unit 1401)

The interview control unit 1401 controls an interview between an interview organizer and an interviewee via the network 1150. For example, the interview control unit 1401 connects the client device 1110 of the interview organizer to the client device 1120 of the interviewee via the network 1150, and controls reception and delivery or the like of interview-related image data and voice data.

(Voice Recognition Unit 1402)

The voice recognition unit 1402 performs voice recognition based on voice data relating to an interview between an interview organizer and an interviewee, converts the voices into texts, and generates text data. The voice recognition unit 1402 classifies, based on waveforms of voices in interviews, speakers in interviews (for example, a sales representative doing business and a customer in sales), and obtains converted character strings (converted texts) for respective speakers. Further, the voice recognition unit 1402 may analyze the converted character strings and classify, based on analysis results, speakers in interviews.

(Storage Processing Unit 1403)

The storage processing unit 1403 stores, in a storage area such as the storage unit 1202, video data relating to interviews and text data obtained by converting voice data relating to interviews into texts, in association with each other, as interview data. In addition to the interview data, the storage processing unit 1403 stores, in the storage unit 1202 or the like, information about date/time of interviews conducted, information about sales representatives and customers, and the like.

(Search Unit 1404)

The search unit 1404 searches multiple sets of interview data stored in the storage unit 1202 or the like based on search conditions including an interviewee's request-related word, and acquires, as search results, multiple sets of interview data corresponding to the search conditions. More specifically, the interviewee's request relates to the function of the server device 1100. In the following description, for the purpose of simplifying the description, the interviewee's request is explained as relating to the function of the server device 1100 unless otherwise mentioned. The search conditions are transmitted from an external device (for example, the client device 1110, the client device 1130, or the like). For example, the search conditions include function-related keywords (words) included in text data of the interview data, information on the duration of interview data serving as a search object, and the like. Further, as described below, the search conditions include identification information indicating whether to search for sentences containing the function-related words or to search for sentences starting with the function-related words.

(Output Control Unit 1405)

The output control unit 1405 performs control to output a search result screen including search results by the search unit 1404. As described below, the search result screen includes a category composition ratio obtained when a function request included in interview data within a corresponding duration is classified into categories.

4. Information Processing

FIG. 16 is an activity diagram illustrating exemplary information processing relating to registration of interview data in the server device 1100.

In A1501, the voice recognition unit 1402 determines whether a request of registering data containing interview video has been received. The interview control unit 1401 controls an online interview between the client device 1110 and the client device 1120 and transmits, in response to detection of termination of the online interview, the request of registering data containing interview video to the voice recognition unit 1402. When the voice recognition unit 1402 determines that the request of registering data containing interview video has been received, the processing is recommended to A1502. When it is determined that the request of registering data containing interview video has not been received, the processing of A1501 is repeated.

In A1502, the voice recognition unit 1402 performs voice recognition based on voice data included in the video, and converts it into texts. Here, the voice recognition unit 1402 classifies speakers in the interview (a sales representative doing business and a customer in sales) based on waveforms of the voice data, and converts the voice data into texts for each speaker. Further, the voice recognition unit 1402 may analyze the converted text, and may classify speakers in the interview, based on analysis results.

As another example, if the client device of the interview organizer and the client device of the interviewee are known, the voice recognition unit 1402 may classify speakers based on which client device has transmitted the voice data. Further, as another example, the voice recognition unit 1402 may store in advance physical amounts such as frequencies of voices of the interview organizer, and may identify the interview organizer by comparing the stored data with the voice data transmitted from the client device to classify the speakers. Further, as another example, the voice recognition unit 1402 may input the voice data into a learned model that has learned in advance about what the interview organizer is likely to speak in the interview, and may classify speakers based on an output indicating whether the voice data is the interview organizer.

In A1503, the storage processing unit 1403 stores interview-related video data, and text data obtained by converting interview-related voice data into texts, in association with each other, as interview data, in the storage area such as the storage unit 1202 or the like. In addition to the interview data, the storage processing unit 1403 stores information about date/time of interviews conducted, information about sales representatives and customers, and the like, in the storage unit 1202 or the like.

FIG. 17 is an activity diagram illustrating exemplary information processing relating to search in the server device 1100.

In A1601, the search unit 1404 determines whether a search request has been received from an external terminal. If the search unit 1404 determines that the search request has been received, the processing proceeds to A1602. If the search unit 1404 determines that no search request has been received, the processing of A1601 is repeated.

In A1602, the search unit 1404 searches interview data based on search conditions corresponding to the search request, and acquires interview data corresponding to the search conditions as search results. Here, the search conditions include, for example, function-related keywords (words) included in text data of the interview data, identification information indicating whether to search for sentences containing the function-related words or to search for sentences starting with the function-related words, information on the duration of interview data serving as a search object, and the like.

When the search conditions include identification information indicating searching for sentences containing a function-related word, the search unit 1404 searches for interview data including the sentence containing the word included in the search conditions, which is interview data in the duration designated by the search conditions, and acquires interview data corresponding to the search conditions as search results. Further, when the search conditions include identification information indicating searching for sentences starting with a function-related word, the search unit 1404 searches for interview data including a document starting with the word included in the search conditions, which is interview data in the duration designated by the search conditions, and acquires interview data corresponding to the search conditions as search results.

In A1603, the output control unit 1405 analyzes the interview data based on the interview data acquired as the search results, and generates a search result screen including the analysis results.

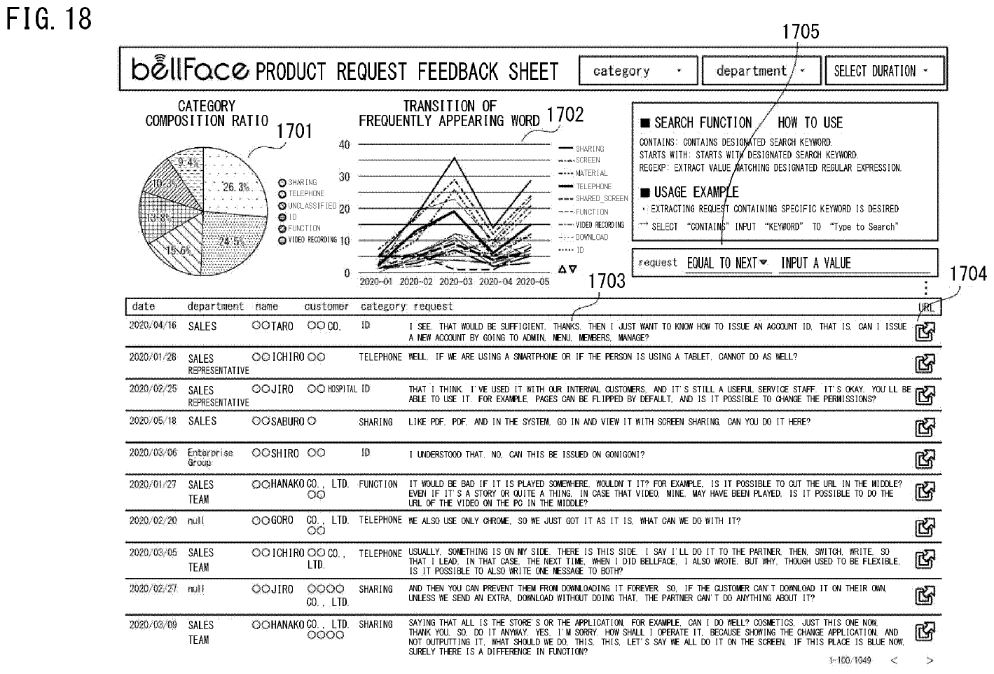

FIG. 18 is a diagram illustrating an exemplary search result screen generated by the output control unit 1405.

The search result screen includes an area 1701, an area 1702, an area 1703, a URL button 1704, and an area 1705.

A pie graph indicating category composition ratios, in which words relating to the function request contained in sentences corresponding to the search conditions are classified into categories, is displayed in the area 1701. The example of FIG. 18 includes sharing, telephone, ID, function, video recording and the like, as the words relating to the function request.

A polygonal line graph indicating transitions of the words relating to the function request included in sentences corresponding to the search conditions in the duration designated by the search conditions is displayed in the area 1702. The example of FIG. 18 includes sharing, screen, material, telephone, shared screen, function, video recording, download, ID and the like, as the word relating to the function request.

The area 1703 includes sentences corresponding to the search conditions. Each sentence corresponding to the search conditions is an example of partial data of the text data including the word relating to the function request. In addition to the sentence corresponding to the search conditions, the search results include interview date/time, information about the interview organizer, information about the interviewee, the word relating to the function request, and the like.

The URL button 1704 is a URL button for reproducing interview-related video data from a sentence portion corresponding to a lateral search condition. The URL button 1704 is an exemplary object that is used to reproduce interview-related video data corresponding to the partial data. When the URL button 1704 is selected, the output control unit 1405 displays a screen and reproduces, in the displayed screen, interview-related video data from a sentence portion corresponding to the search conditions, which is associated with the URL button 1704. The interview-related video data from the sentence portion corresponding to the search conditions, which is associated with the URL button 1704, is an example of the interview-related video data corresponding to the partial data.

In A1604, the output control unit 1405 performs control to output the search result screen generated in A1603 to the output unit 1305 of the client device being a request source.

The area 1705 is an area for designating the search conditions. In the area 1705, it is possible to designate whether to search for interview data including a sentence containing a designated word or to search for interview data including a document starting with a designated word.

According to the embodiment 2, as illustrated in FIG. 18, words relating to an interviewee's request are classified into categories and displayed as category composition ratios. Therefore, it is possible to immediately comprehend which words relating to the interviewee's request have frequently appeared in the designated duration. Further, the temporal transition of the words relating to the interviewee's request is displayed. Accordingly, it is possible to immediately comprehend whether the number of words relating to which request of the interviewee is increasing or decreasing with the temporal transition, or the like. Further, when the URL button 1704 is selected, reproduction of the video recording data relating to the interview starts from a point at which the request-related word appears. Therefore, it is possible to immediately comprehend the atmosphere, intonation, strength, or the like at the time the word was spoken.

As another example, the server device 1100 may be configured to be able to register a request category based on each request from the client device. Further, the server device 1100 may be configured to be able to machine-learn words of the registered category and relevant words in the text data obtained by converting interview-related voice data into texts. In such a configuration, the request is not limited to the one relating to the function of the server device 1100.

### Modified Example 2

In the above-described embodiment, the description has been given assuming that the server device 1100, which is a single device, performs processing. However, the above-described functions and processing can be implemented even when the processing of the server device 1100 is executed by multiple devices, for example, control units of respective server devices of an information processing system configured by multiple server devices based on programs stored in storage units of respective server devices.

<Supplementary Note>

The invention may be provided in each of the following aspects.

In the information processing system, the search result screen includes a transition-in-duration of the request-related word.

In the information processing system, the search result screen includes partial data of the text data including request-related word, and an object used to reproduce interview-related video data corresponding to the partial data.

In the information processing system, when the object is selected, the control unit performs control to reproduce the interview-related video data corresponding to the partial data.

In the information processing system, the control unit performs control to display a screen including an area for designating the search conditions, so that it is possible to designate, in this area, whether to search for interview data including a sentence containing a designated word or to search for interview data including a document starting with the designated word.

In the information processing system, the request relates to a function of the information processing system.

An information processing method to be executed by an information processing system includes generating text data obtained by converting voice data relating to an interview with an interviewee into texts, storing the interview-related video data and the text data in association with each other, as interview data, in a storage area, searching for multiple sets of the interview data based on search conditions including an interviewee's request-related word, and performing control to output a search result screen including search results, in which the search result screen includes a category composition ratio obtained when the request is classified into categories.

A program causes a computer to function as a control unit of the information processing device.

It is needless to say that the invention is not limited to the above.

For example, a computer-readable non-transitory storage medium storing the above-described programs may be provided.

Further, in the above-described embodiment or the like, the description has been given assuming that the server device 1100 generates the search result screen and transmits it to the client device. However, the server device 1100 may transmit data necessary to generate the search result screen to the client device, and the client device may generate the search result screen based on the data.

### Embodiment 3

1. System Configuration

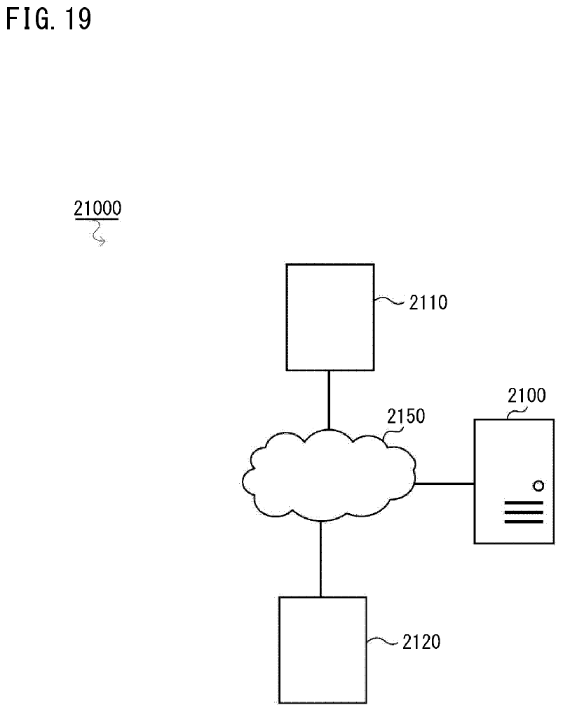

FIG. 19 is a diagram illustrating an exemplary system configuration of an information processing system 21000. As illustrated in FIG. 19, the information processing system 21000 includes, as the system configuration, a server device 2100, a client device 2110, and a client device 2120. The client device 2110 is a personal computer (PC) or the like of an interview organizer. The client device 2120 is a PC or the like of an interviewee. The interview organizer is a person who has hosted an interview, and is referred to as a host side. The interviewee is a partner of the interview organizer in the interview, and is referred to as a guest side. The host side or the guest side accesses, for example, a predetermined URL to conduct a Web conference over the Internet. For example, the interview organizer copies the URL of the Web conference and shares it with guests by e-mail or the like.

When the interview is a business negotiation, the interview organizer is a sales representative and the interviewee is a customer in sales. When the interview is a recruiting interview, the interview organizer is a person in charge of interviews at a company or the like that conducts recruiting interviews, and the interviewee is an applicant who is applying for recruitment of the company. The interviews are not limited to the above-described examples and include those in which multiple users interact with each other by means of screens and voices over the Internet. Further, each of the interview organizer and the interviewee is not limited to one person. The interview organizer and the interviewee are an example of the multiple users.

The server device 2100, the client device 2110, and the client device 2120 are connected via a network 2150 so that they can communicate with each other.

For the purpose of simplifying the description, FIG. 19 illustrates the information processing system 21000 including only one client device 2110 and only one client device 2120. However, each constituent of the information processing system 21000 may be configured by two or more devices. Further, the client device is not limited to a PC and may be a smartphone, a tablet computer, or the like. When an interview is conducted in the information processing system 21000, images and the like are exchanged over the Internet and voices are exchanged via a telephone network, but they are not limited to these examples.

Each information processing system described in the claims may be configured by multiple devices (for example, by the server device and the client device, or by multiple server devices) or may be configured by a single device (for example, by the server device).

2. Hardware Configuration

(1) Hardware Configuration of Server Device 2100

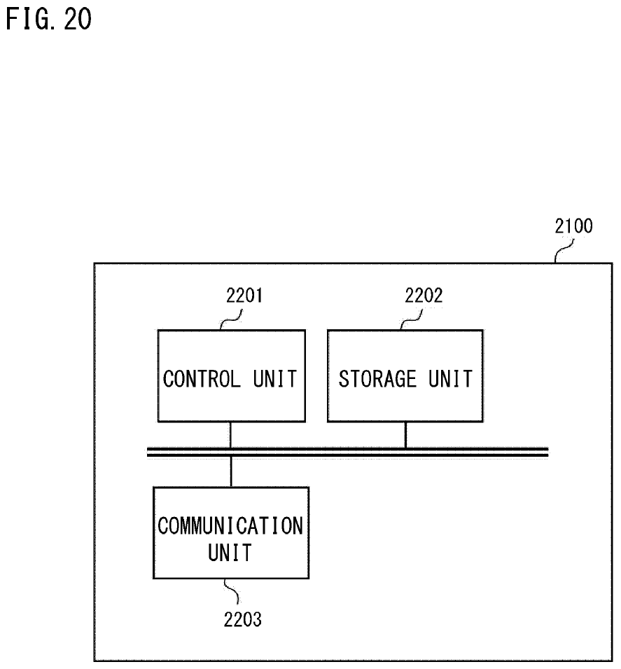

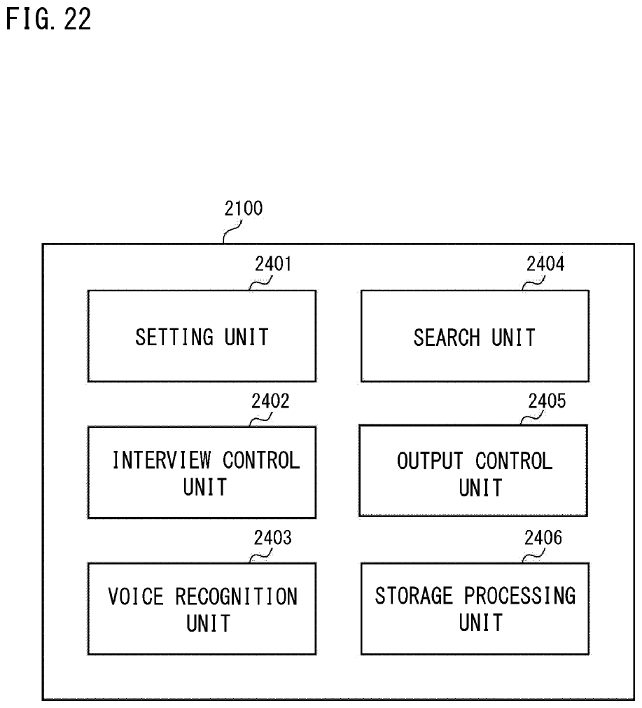

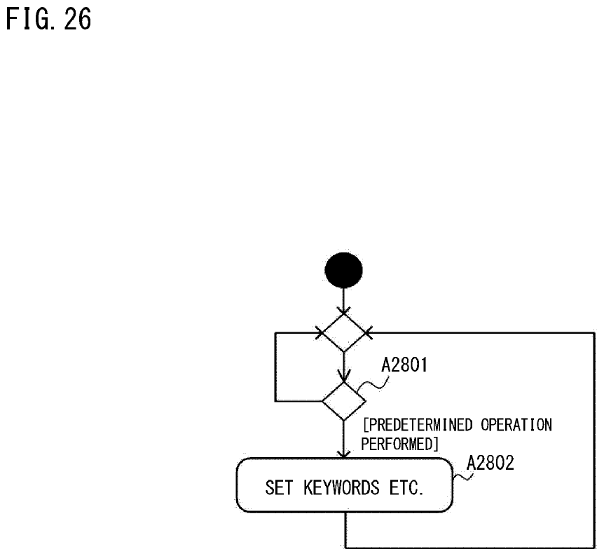

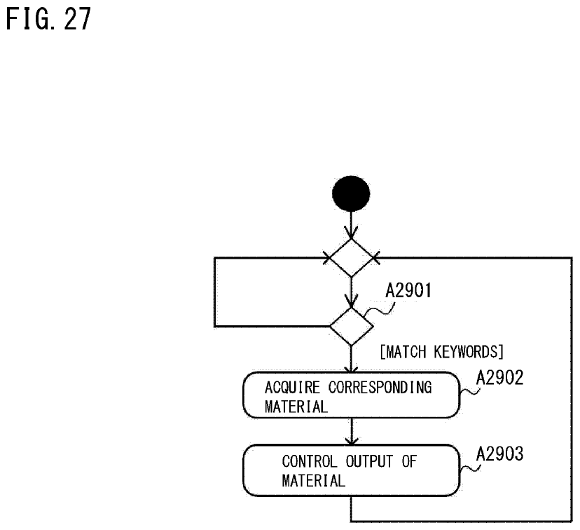

FIG. 20 is a diagram illustrating an exemplary hardware configuration of the server device 2100. The server device 2100 includes, as the hardware configuration, a control unit 2201, a storage unit 2202, and a communication unit 2203. The control unit 2201 is a central processing unit (CPU) or the like, which entirely controls the server device 2100. The storage unit 2202 is a hard disk drive (HDD), a read only memory (ROM), a random access memory (RAM) or the like, which stores programs and data or the like to be used when the control unit 2201 executes processing based on the programs. The control unit 2201 executing processing based on the programs stored in the storage unit 2202 can realize a function configuration of the server device 2100 described below with reference to FIG. 22 and processing of activity diagrams described below with reference to FIGS. 26 and 27. The communication unit 2203 is a network interface card (NIC) or the like, which connects the server device 2100 to the network 2150 and controls communications with other devices (for example, the client device 2110, the client device 2120 and the like). The storage unit 2202 is an exemplary storage medium.

(2) Hardware Configuration of Client Device 2110

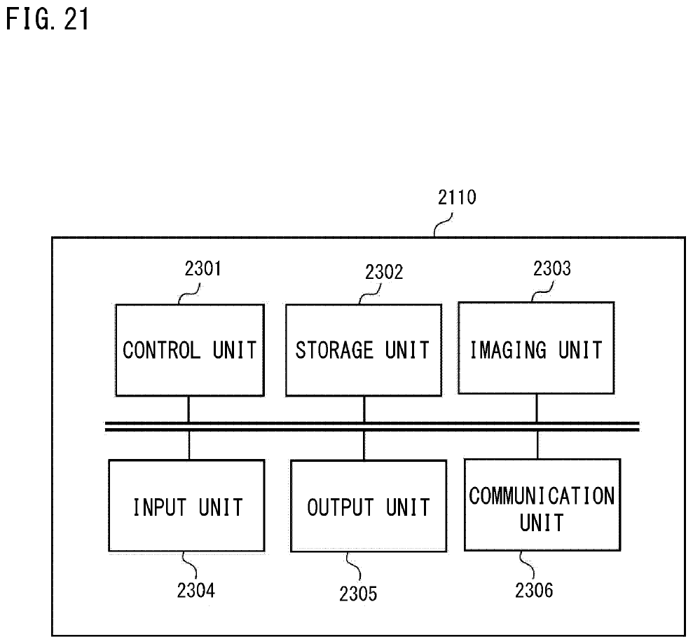

FIG. 21 is a diagram illustrating an exemplary hardware configuration of the client device 2110. The client device 2110 includes, as the hardware configuration, a control unit 2301, a storage unit 2302, an imaging unit 2303, an input unit 2304, an output unit 2305, and a communication unit 2306. The control unit 2301 is a CPU or the like, which entirely controls the client device 2110. The storage unit 2302 is a HDD, a ROM, a RAM or the like, which stores programs and data or the like to be used when the control unit 2301 executes processing based on the programs. The control unit 2301 executing processing based on the programs stored in the storage unit 2302 can realize functions of the client device 2110. The imaging unit 2303 is a camera or the like and captures an image of a user of the client device 2110. Examples of the input unit 2304 includes a mouse and a keyboard, which input user operations to the control unit 2301. Another example of the input unit 2304 is a microphone or the like which inputs user voices to the control unit 2301. Examples of the output unit 2305 include a display device and a speaker, which output processing results or the like by the control unit 2201 by display or voice. The communication unit 2306 is a NIC or the like, which connects the client device 2110 to the network 2150 and controls communications with other devices (for example, the server device 2100, the client device 2120, and the like).

The hardware configuration of the client device 2120 may be similar to the hardware configuration of the client device 2110. A control unit of the client device 2120 executing processing based on the programs stored in the storage unit of the client device 2120 can realize functions of the client device 2120. Similarly, a control unit of the client device executing processing based on the programs stored in the storage unit of the client device can realize functions of the client device.

3. Function Configuration

FIG. 22 is a diagram illustrating an exemplary function configuration of the server device 2100. As illustrated in FIG. 22, the server device 2100 includes, as the function configuration, a setting unit 2401, an interview control unit 2402, a voice recognition unit 2403, a search unit 2404, an output control unit 2405, and a storage processing unit 2406.

(Setting Unit 2401)

For example, the setting unit 2401 sets a combination of keywords by storing the combination of keywords in the storage unit 2202 or the like according to a setting operation via an input unit or the like of a client device having administrator rights. The storage unit 2202 is an exemplary storage area. The combination of keywords set by the setting unit 2401 is a combination of keywords that is likely to appear in interviews, and is a combination of keywords that serves as a trigger for displaying the material to be used in interviews.

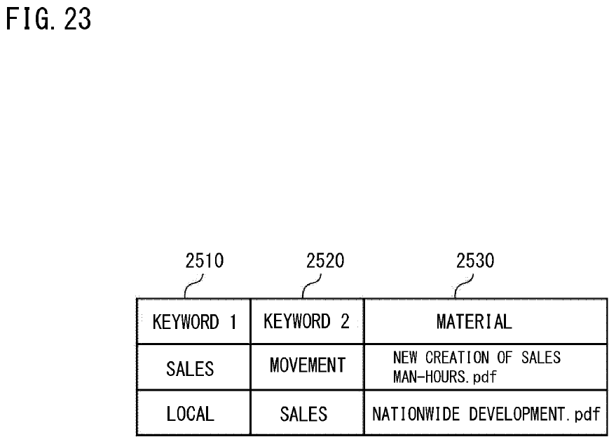

FIG. 23 is a diagram illustrating exemplary keyword combinations or the like set by the setting unit 2401. A table illustrated in FIG. 23 is, for example, stored in the storage unit 2202. Although two keywords are described in FIG. 23 as an exemplary combination of keywords, the combination of keywords is not limited to two keywords, and more keywords may be combined. Further, the number of keywords may vary, such as two keywords, three keywords, or the like, depending on the material relating to the keywords. In FIG. 23, an item 2510 is for setting a first keyword. An item 2520 is for setting a second keyword to be paired with the first keyword. An item 2530 is for setting material to be displayed when a corresponding combination of keywords appears. In the item 2530, the material itself may be set, or uniform resource locator (URL) or the like of a storage destination where the material is stored may be set. That is, the setting unit 2401 stores, in the storage unit 2202 or the like, the keyword combination and the material in association with each other.

(Interview Control Unit 2402)

The interview control unit 2402 connects the interview organizer and the interviewee to an interview via the network 2150. The network 2150 is an example of the Internet. Further, the interview control unit 2402 controls the interview between the interview organizer and the interviewee via the network 2150. For example, the interview control unit 2402 connects the client device 2110 of the interview organizer to the client device 2120 of the interviewee via the network 2150, and controls reception and delivery or the like of image data and voice data relating to the interviews.

(Voice Recognition Unit 2403)

The voice recognition unit 2403 receives voices of interview organizers and interviewees during interviews. Further, the voice recognition unit 2403 performs voice recognition based on voice data relating to interviews between interview organizers and interviewees, converts the voices into texts, and generates text data. The voice recognition unit 2403 classifies, based on waveforms of voices in interviews, speakers in interviews (for example, a sales representative doing business and a customer in sales), and obtains converted character strings (converted texts) for respective speakers. Further, the voice recognition unit 2403 may analyze the converted character strings and classify, based on analysis results, speakers in interviews. The voice recognition unit 2403 stores the generated text data in the storage unit 2202 or the like.

As another example, if the client device of the interview organizer and the client device of the interviewee are known, the voice recognition unit 2403 may classify speakers based on which client device has transmitted the voice data. Further, as another example, the voice recognition unit 2403 may store in advance physical amounts such as frequencies of voices of the interview organizer, and may identify the interview organizer by comparing the stored data with the voice data transmitted from the client device to classify the speakers. Further, as another example, the voice recognition unit 2403 may input the voice data into a learned model that has learned in advance about what the interview organizer is likely to speak in the interview, and may classify speakers based on an output indicating whether the voice data is the interview organizer.

(Search Unit 2404)

The search unit 2404 searches, for a combination of keywords set by the setting unit 2401 in an interview between an interview organizer and an interviewee, text data generated by the voice recognition unit 2403 and stored in the storage unit 2202 or the like. This processing of the search unit 2404 is exemplary processing for detecting, from received voices, a combination of keywords that has been set. When the combination of keywords appears, the search unit 2404 acquires the material relating to the combination of keywords. More specifically, the search unit 2404 searches to check whether the combination of keywords set by the setting unit 2401 is included in the same sentence of the text data generated successively by the voice recognition unit 2403, and when the combination of keywords set by the setting unit 2401 is included in the same sentence, acquires the material relating to the combination of keywords. For example, when “sales” and “movement” have appeared in the same sentence of the text data generated successively by the voice recognition unit 2403, the search unit 2404 acquires “new creation of sales man-hours.pdf” relating to “sales” and “movement”, as the material.

(Output Control Unit 2405)

The output control unit 2405 controls screen display for the client device 2110 of the interview organizer and the client device 2120 of the interviewee, during the interview. For example, the output control unit 2405 controls display of live video, display of material, display of Web site, display of minute book, and the like. Further, when the combination of keywords being set is detected from the received voices, the output control unit 2405 outputs the material relating to the combination of keywords, in a manner comprehensible to at least one of the multiple users. More specifically, when the search unit 2404 has acquired the material, the output control unit 2405 performs control to display the material acquired by the search unit 2404 on interview screens of the interview organizer and the interviewee. That is, in the interview between the interview organizer and the interviewee over the Internet, in response to detection of the combination of keywords, the output control unit 2405 performs control to display the material relating to the combination of keywords on the screens during the interview.

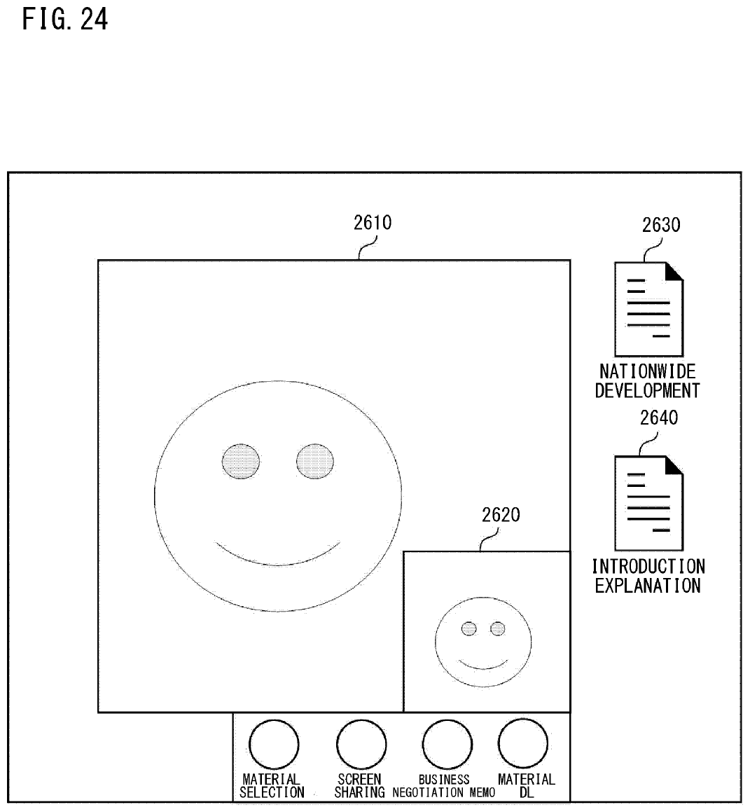

FIG. 24 is a diagram (Part 1) illustrating an exemplary interview screen on which material is displayed. The interview screen of FIG. 24 is an exemplary interview screen displayed on the output unit 2305 of the client device 2110 of the interview organizer. The interview screen of the interview organizer side includes an area 2610 and an area 2620. A video of the interviewee captured by an imaging unit of the client device 2120 of the interviewee is displayed in the area 2610. A video of the interview organizer captured by the imaging unit 2303 of the client device 2110 of the interview organizer is displayed in the area 2620. Further, material 2630 and material 2640 are displayed by the output control unit 2405 on the interview screen of FIG. 24. The material 2630 and the material 2640 are icons and, in response to selection of an icon, the output control unit 2405 displays contents of the material corresponding to the selected icon. After displaying the material 2630 and the material 2640 on the interview screen for a predetermined time, the output control unit 2405 terminates the display of the material 2630 and the material 2640.

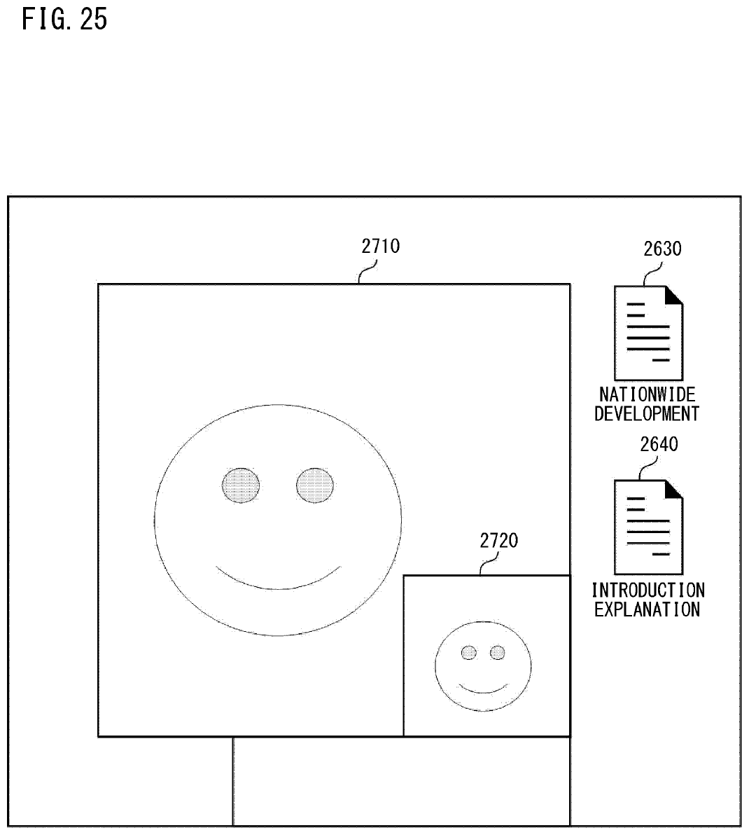

FIG. 25 is a diagram (Part 2) illustrating an exemplary interview screen on which material is displayed. The interview screen of FIG. 25 is an exemplary interview screen displayed on the output unit of the client device 2120 of the interviewee. The interview screen of the interviewee includes an area 2710 and an area 2720. A video of the interview organizer captured by the imaging unit 2303 of the client device 2110 of the interview organizer is displayed in the area 2710. A video of the interviewee created under pressure by the imaging unit of the client device 2120 of the interviewee is displayed in the area 2720. Further, similar to the interview screen of FIG. 24, the output control unit 2405 displays the material 2630 and the material 2640 on the interview screen of FIG. 25. The material 2630 and the material 2640 are icons and, in response to selection of an icon, the output control unit 2405 displays contents of the material corresponding to the selected icon. After displaying the material 2630 and the material 2640 on the interview screen for a predetermined time, the output control unit 2405 terminates the display of the material 2630 and the material 2640.

(Storage Processing Unit 2406)

The storage processing unit 2406 stores, in a storage area such as the storage unit 2202, video data relating to interviews and text data obtained by converting voice data relating to interviews into texts, in association with each other, as interview data. In addition to the interview data, the storage processing unit 2406 stores, in the storage unit 2202 or the like, information about date/time of interviews conducted, information about the interview organizer, information about the interviewee, and the like. Further, when the material that is pop-up displayed during the interview is selected and the material is displayed on an output unit of a client device side at which the material is selected, the storage processing unit 2406 stores, in the storage unit 2202 or the like, interview-related video data, text data obtained by converting the interview-related voice data into texts, identification information for identifying the selected material, information on time when the material has been selected and displayed, in association with each other, as interview data.

4. Information Processing

(1) Information Processing Relating to Keyword Setting

FIG. 26 is an activity diagram illustrating exemplary information processing relating to keyword setting in the server device 2100.

In A2801, the setting unit 2401 determines whether a setting operation has been performed via an input unit or the like of a client device. When the setting unit 2401 determines that the setting operation has been performed, the processing proceeds to A2802. When the setting unit 2401 determines that no setting operation has been performed, the processing of A2801 is repeated.

In A2802, the setting unit 2401 sets a combination of keywords according to a setting operation or the like via an input unit or the like of a client device having administrator rights.

(2) Information Processing Relating to Output of Material

FIG. 27 is an activity diagram illustrating exemplary information processing relating to output of material in the server device 2100.

In A2901, the search unit 2404 searches, for the combination of keywords set by the setting unit 2401 in the interview between the interview organizer and the interviewee, the text data generated by the voice recognition unit 2403 and stored in the storage unit 2202 or the like, and determines whether the combination of keywords appears. When the search unit 2404 determines that the combination of keywords appears in the text data, the processing proceeds to A2902. When the search unit 2404 determines that the combination of keywords that has been set has not appeared in the text data, the processing of A2901 is repeated.

When FIG. 23 is referred to for explanation, the search unit 2404 determines whether “sales” and “movement” have appeared in the same sentence of the text data. When the search unit 2404 determines that “sales” and “movement” have appeared in the same sentence of the text data, the processing proceeds to A2902. If it is determined that “sales” and “movement” have not appeared in the same sentence of the text data, then the search unit 2404 determines whether “local” and “sales” have appeared in the same sentence of the text data. When the search unit 2404 determines that “local” and “sales” have appeared in the same sentence of the text data, the processing proceeds to A2902. When the search unit 2404 determines that “local” and “sales” have not appeared in the same sentence of the text data, the processing returns to A2901, in which it is determined whether the combination of keywords appears in the next text data generated by the voice recognition unit 2403.

In A2902, the search unit 2404 acquires the material relating to the keywords having appeared in the same sentence of the text data.

In A2903, the output control unit 2405 performs control to display the material acquired by the search unit 2404 on corresponding interview screens of the interview organizer and the interviewee.

According to the embodiment 3, when the combination of keywords having been set appears in the interview, it is possible to display the material relating to the keywords on the screen during the interview. Accordingly, it is possible to quickly acquire necessary material without taking any time and effort of searching for and displaying the material matching with the contents of the interview while conducting the interview and perform detailed explanation or the like using the acquired material in the interview.

### Modified Example 3

In the embodiment 3, the description has been given assuming that the server device 2100 displays the same material to the interview organizer and the interviewee. However, the output control unit 2405 of a modified example 3 controls whether to display, according to a combination of keywords, the material relating to the combination of keywords only on an interview organizer side screen during the interview or only on an interviewee side screen during the interview.

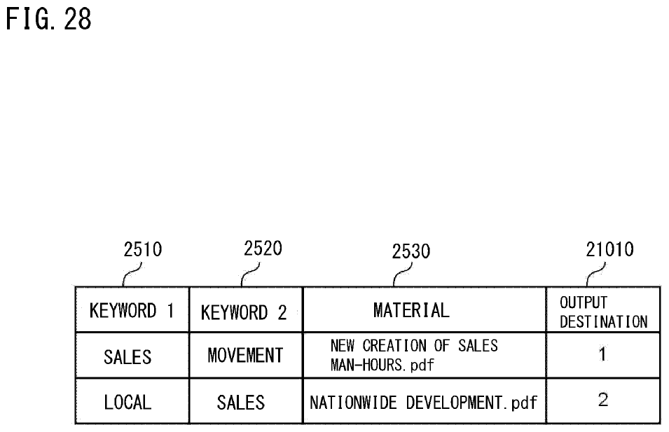

FIG. 28 is a diagram illustrating exemplary keyword combinations or the like set by the setting unit 2401 of the modified example 3. A table illustrated in FIG. 28 is, for example, stored in the storage unit 2202. The table of FIG. 28 is different from the table of the embodiment 3 illustrated in FIG. 23 in that an item 21010 is newly added. For example, the item 21010 includes settings of 1, 2, 3 or the like. “1” indicates displaying the relevant material to the interview organizer. “2” indicates displaying the relevant material to the interviewee. “3” indicates displaying the relevant material to both the interview organizer and the interviewee.

That is, the setting unit 2401 sets the combination of keywords, the material to be displayed when the combination of keywords appears in the interview, and the display destination, in association with each other.

The search unit 2404 of the modified example 3 searches, for the combination of keywords set by the setting unit 2401 in the interview between the interview organizer and the interviewee, the text data generated by the voice recognition unit 2403 and stored in the storage unit 2202 or the like, and acquires the material relating to the combination of keywords when the combination of keywords appears. Further, the search unit 2404 acquires information on an output destination of the material relating to the combination of keywords (information about the above-described 1, 2, 3 or the like). When the search unit 2404 has acquired the material, the output control unit 2405 performs control to display the material acquired by the search unit 2404 on the interview screen, based on the information on the output destination acquired by the search unit 2404. That is, the output control unit 2405 controls, according to the combination of keywords, whether to display the material relating to the combination of keywords on the screen of the client device 2110 of the interview organizer or on the screen of the client device 2120 of the interviewee, or on both the screen of the client device 2110 of the interview organizer and the screen of the client device 2120 of the interviewee.

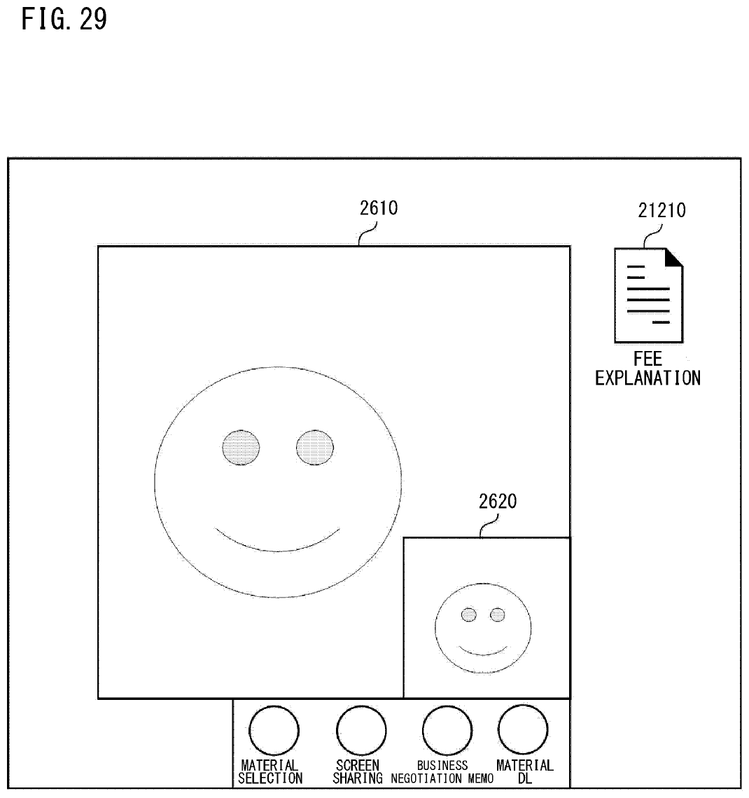

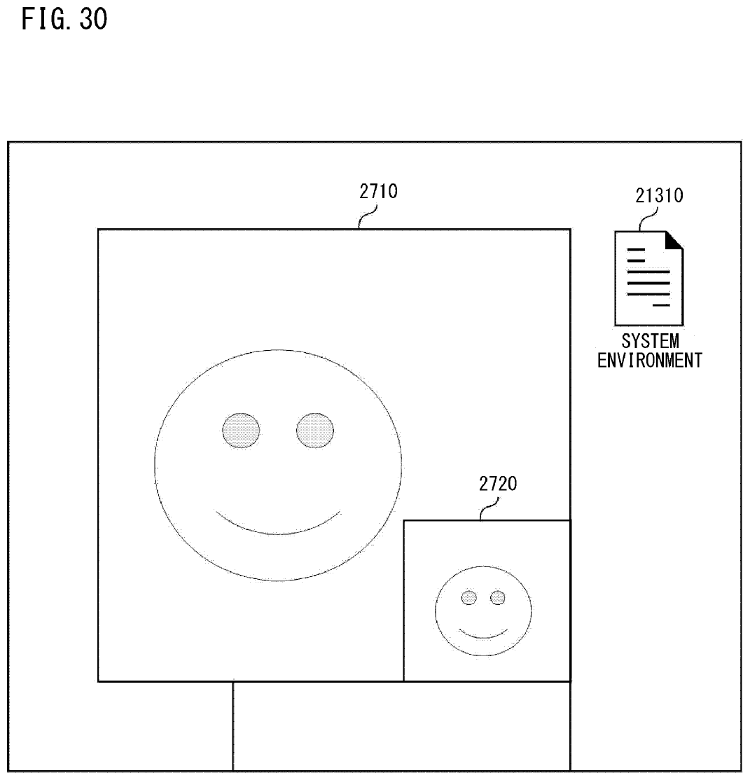

FIG. 29 is a diagram (Part 3) illustrating an exemplary interview screen on which material is displayed. FIG. 30 is a diagram (Part 4) illustrating an exemplary interview screen on which material is displayed. The interview screen of FIG. 29 is an exemplary interview screen displayed on the output unit 2305 of the client device 2110 of the interview organizer. The interview screen of FIG. 30 is an exemplary interview screen displayed on the output unit of the client device 2120 of the interviewee. The interview screens of FIGS. 29 and 30 are interview screens displayed on the output units of respective client devices at the same time. On the interview screen of FIG. 29, material 21210 is displayed by the output control unit 2405. On the interview screen of FIG. 30, material 21310 is displayed by the output control unit 2405.

According to the modified example 3, it is possible to change the output destination of material according to the combination of keywords.

### Modified Example 4

In the embodiment 3, the server device 2100 outputs the material relating to the combination of keywords when the combination of keywords is included in the text data generated based on the voice data relating to the interview between the interview organizer and the interviewee. The server device 2100 of a modified example 4 performs control to change the material to be displayed on the screen during the interview depending on the combination of keywords as well as information indicating whether the combination of keywords is given from the interview organizer or given from the interviewee.

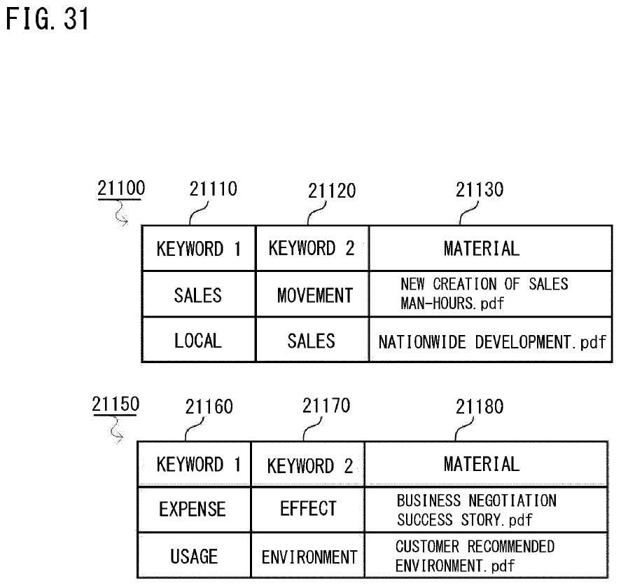

FIG. 31 is a diagram illustrating exemplary keyword combinations set by the setting unit 2401 of the modified example 4. A table 21100 illustrated in FIG. 31 is a table for setting a combination of keywords or the like for the interview organizer. A table 21150 is a table for setting a combination of keywords or the like for the interviewee. Items included in the table 21100 are an item 21110, an item 21120, and an item 21130. The item 21110 is for setting a first keyword. The item 21120 is for setting a second keyword to be paired with the first keyword. The item 21130 is for setting material to be displayed when a corresponding combination of keywords appears. In the item 21130, the material itself may be set, or URL or the like of a storage destination where the material is stored may be set. The items of the table 21150 are similar to the items of the table 21100.

The voice recognition unit 2403 of the modified example 4 classifies, based on waveforms of voices in interviews, speakers in interviews (for example, a sales representative doing business and a customer in sales), and obtains converted character strings (converted texts) for respective speakers. More specifically, the voice recognition unit 2403 separates speakers based on waveforms of voices in the interview, and generates text data relating to the interview organizer and text data relating to the interviewee. The search unit 2404 of the modified example 4 searches, for the combination of keywords set in the table 21100, the same sentence in the text data relating to the interview organizer generated by the voice recognition unit 2403 and stored in the storage unit 2202 or the like. When the combination of keywords appears, the search unit 2404 acquires the material relating to the combination of keywords. Similarly, the search unit 2404 searches, for the combination of keywords set in the table 21150, the same sentence in the text data relating to the interviewee generated by the voice recognition unit 2403 and stored in the storage unit 2202 or the like. When the combination of keywords appears, the search unit 2404 acquires the material relating to the combination of keywords. That is, the output control unit 2405 of the modified example 4 performs control to change the material to be displayed on the screen during the interview depending on the combination of keywords as well as information indicating whether the combination of keywords is included in the text data obtained from voices of the interview organizer or included in the text data obtained from voices of the interviewee. More specifically, the output control unit 2405 performs control to switch the display of the material relating to the combination of keywords between the screen of the client device 2110 of the interview organizer and the screen of the client device 2120 of the interviewee, depending on the combination of keywords as well as information indicating whether the combination of keywords is included in the text data obtained from voices of the interview organizer or in the text data obtained from voices of the interviewee. Further, the output control unit 2405 may perform control to switch the display of the material relating to the combination of keywords on the screen of the client device 2110 of the interview organizer, on the screen of the client device 2120 of the interviewee, or on both the screen of the client device 2110 of the interview organizer and the screen of the client device 2120 of the interviewee, depending on the combination of keywords as well as information indicating whether the combination of keywords is included in the text data obtained from voices of the interview organizer or in the text data obtained from voices of the interviewee.

According to the modified example 4, when the interview organizer speaks the combination of keywords of the interview organizer during the interview, the material relating to the combination of keywords of the interview organizer is displayed during the interview. Further, when the interviewee speaks the combination of keywords of the interviewee during the interview, the material relating to the combination of keywords of the interviewee is displayed during the interview. Therefore, according to the modified example 4, it is possible to perform control to display the material more appropriately. In the modified example 4, the description has been given using an example in which two tables are provided. However, these tables may be replaced by only one table if it is possible to discriminate whether the settings with respect to the keyword combination and the material are given from the interview organizer or given from the interviewee.

### Modified Example 5

In the above-described embodiment, the search unit 2404 performs searching to check whether the combination of keywords set by the setting unit 2401 is included in the same sentence of the text data. However, the search unit 2404 may determine whether the second keyword appears within a predetermined number of characters (for example, 20 characters) after the first keyword appears in the text data. In such a configuration, if the second keyword appears within the predetermined number of characters (for example, 20 characters) after the first keyword appears in the text data, the search unit 2404 acquires the material relating to the combination of keywords.

Further, the search unit 2404 may determine whether the second keyword appears in the text data relating to the voice data within a predetermined time (for example, one minute) after the first keyword appears in the text data. In such a configuration, if the second keyword appears in the text data relating to the voice data within the predetermined time (for example, one minute) after the first keyword appears in the text data, the search unit 2404 acquires the material relating to the combination of keywords.

Effects similar to those of the above-described embodiment 3 can also be obtained by the modified example 5.

### Modified Example 6

In the above-described embodiment, for example, when the table of FIG. 23 is used as an example for explanation, the search unit 2404 acquires the material relating to the combination of keywords when keyword 2 appears following keyword 1 in the text data. However, the search unit 2404 of a modified example 6 may acquire the material relating to the combination of keywords when the combination of keywords appears in the text data not only in the order from keyword 1 to keyword 2 but also in the order from keyword 2 to keyword 1.

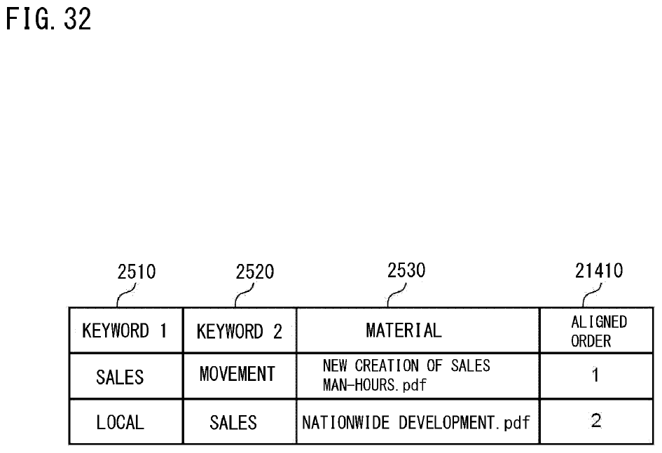

FIG. 32 is a diagram illustrating exemplary keyword combinations set by the setting unit 2401 of the modified example 6. The table illustrated in FIG. 32 is, for example, stored in the storage unit 2202. The table of FIG. 32 is different from the table of the embodiment 3 illustrated in FIG. 23 in that an item 21410 is newly added. For example, the item 21410 includes settings of “1” and “2” or the like, in which “1” indicates searching according to the order from keyword 1 to keyword 2, and “2” indicates searching regardless of the order of keyword 1 and keyword 2.

When searching the text data generated by the voice recognition unit 2403 and stored in the storage unit 2202 or the like for the combination of keywords set by the setting unit 2401 in the interview between the interview organizer and the interviewee, if the value of the item 21410 is “1”, the search unit 2404 of the modified example 4 searches for a keyword combination aligned in the order of keyword 1 to keyword 2. Further, when the value of the item 21410 is “2”, the search unit 2404 searches for not only a keyword combination aligned in the order of keyword 1 to keyword 2, but also a keyword combination aligned in the order of keyword 2 to keyword 1.

According to the modified example 6, it is possible to set whether to search for a combination of keywords aligned in a determined order, or to search for a combination of keywords aligned regardless of the order.

### Modified Example 7

In the above-described embodiment or the like, the description has been given assuming that the setting unit 2401 sets the combination of keywords according to the setting operation via, for example, the input unit or the like of the client device having administrator rights. However, the setting unit 2401 of a modified example 7 may generate a learned model capable of learning a combination of keywords while the material is displayed, based on text data converted into texts based on the voice data relating to the interview and the material displayed in the interview. In addition, the setting unit 2401 may set, based on the learned model, the combination of keywords and the material to be displayed when the combination of keywords appears in the interview, in association with each other.

According to the modified example 7, the keyword combination and the material can be automatically set in association with each other. Further, repeating the learning can improve the accuracy of the material to be output.

### Modified Example 8

In the above-described embodiment, the description has been given assuming that the server device 2100, which is a single device, performs processing. However, the above-described functions and processing can be implemented even when the processing of the server device 2100 is executed by multiple devices, for example, control units of respective server devices of an information processing system configured by multiple server devices based on programs stored in storage units of respective server devices.

<Supplementary Note>

The invention may be provided in each of the following aspects.

In the information processing system, the control unit displays, in response to detection of the combination of keywords, the material relating to the combination of keywords on a screen during the interview.

In the information processing system, the control unit performs voice recognition on the received voices, generates text data, and displays, in response to detection of the combination of keywords being set in the generated text data, the material relating to the combination of keywords, on a screen during the interview.

In the information processing system, the control unit sets the combination of keywords by storing the combination of keywords in a storage area.

In the information processing system, the control unit stores the combination of keywords and the material in association with each other in the storage area.

In the information processing system, the multiple users include an interview organizer side user and an interviewee side user, and the control unit controls, according to the combination of keywords, whether to display the material relating to the combination of keywords on an interview organizer side screen during the interview or on an interviewee side screen during the interview.

In the information processing system, the control unit controls, according to the combination of keywords, whether to display the material relating to the combination of keywords on the interview organizer side screen during the interview or on the interviewee side screen during the interview, or on both the interview organizer side screen and the interviewee side screen during the interview.

In the information processing system, the multiple users include an interview organizer side user and an interviewee side user, and the control unit changes the material to be displayed on the screen during the interview depending on the combination of keywords, and information indicating whether the combination of keywords is included in a voice of the interview organizer side or in a voice of the interviewee side.

In the information processing system, the multiple users include an interview organizer side user and an interviewee side user, and the control unit controls whether to display the material relating to the combination of keywords on an interview organizer side screen or on an interviewee side screen, depending on the combination of keywords, and information indicating whether the combination of keywords is included in a voice of the interview organizer side or in a voice of the interviewee side.

In the information processing system, the control unit controls whether to display the material relating to the combination of keywords on the interview organizer side screen, or on the interviewee side screen, or on both the interview organizer side screen and the interviewee side screen, depending on the combination of keywords, and information indicating whether the combination of keywords is included in a voice of the interview organizer side or in a voice of the interviewee side.

An information processing method to be executed by the information processing system includes connecting multiple users to an interview over the Internet, receiving voices of the multiple users during the interview, and outputting, when a combination of keywords being set is detected from the received voices, material relating to the combination of keywords, in a manner comprehensible to at least one of the multiple users.

A program causes a computer to function as a control unit of the information processing system.

It is needless to say that the invention is not limited to the above.

For example, a computer-readable non-transitory storage medium storing the above-described programs may be provided.

Further, an arbitrary combination of the above-described embodiments and modified examples may be implemented.

Further, in the above-described embodiments or the like, an example in which the server device 2100 generates a screen and transmits it to the client device has been described. However, the server device 2100 may transmit data for generating a screen to the client device and the client device having received the data may generate a screen based on the received data.

Finally, although various embodiments of the present invention have been described, these embodiments are mere examples and are not intended to limit the scope of the invention. Novel embodiments can be implemented in various other forms, and various omissions, replacements, and changes can be made without departing from the gist of the invention. These embodiments and modifications thereof are encompassed in the scope and gist of the present invention, and are also encompassed in the scope of the invention described in the claims and equivalents thereof.

### REFERENCE SIGNS LIST

100, 1100, 2100: server device
150, 1150, 2150: network
201, 301, 1201, 1301, 2201, 2301: control unit
202, 302, 1202, 1302, 2202, 2302: storage unit
203, 306, 1203, 1306, 2203, 2306: communication unit
303, 1303, 2303: imaging unit
304, 1304, 2304: input unit
305, 1305, 2305: output unit
401, 1401, 2402: interview control unit
402 management unit
403: analysis unit
404: display control unit
1000, 11000, 21000: information processing system
1110, 1120, 1130, 2110, 2120, 2130: client device
1402, 2403: voice recognition unit
1403, 2406: storage processing unit
1404, 2404: search unit
1405, 2405: output control unit
2401: setting unit

1. An information processing system comprising
a control unit, wherein
the control unit:
controls an interview between an interview organizer and an interviewee over the Internet; and
displays, after termination of the multiple interviews, in response to a display request, a communication index relating to an interview between a first interview organizer and an interviewee of the first interview organizer and a communication index relating to an interview between a second interview organizer and an interviewee of the second interview organizer, in a comparable manner.

2. The information processing system according to claim 1, wherein
the communication index includes information on a speaking tendency during the interview.

3. The information processing system according to claim 1, wherein
the communication index includes information on a conversation tendency during the interview.

4. The information processing system according to claim 1, wherein
the communication index includes information on a use situation of material used in the interview.

5. The information processing system according to claim 1, wherein
the communication index includes information on behavior of the interviewee in the interview.

6. The information processing system according to claim 1, wherein
the communication index includes an amount of money spoken by the interviewer during the interview and a number of speaking times.

7. The information processing system according to claim 1, wherein
the control unit:
acquires first data relating to the interview between the first interview organizer and the interviewee of the first interview organizer, and second data relating to the interview between the second interview organizer and the interviewee of the second interview organizer; and
displays in response to a display request, based on the first data and the second data, the communication index between the first interview organizer and the interviewee of the first interview organizer and the communication index between the second interview organizer and the interviewee of the second interview organizer, in a comparable manner.

8. The information processing system according to claim 7, wherein
the first data includes sound recording data relating to the interview between the first interview organizer and the interviewee of the first interview organizer, and
the second data includes sound recording data relating to the interview between the second interview organizer and the interviewee of the second interview organizer.

9. The information processing system according to claim 7, wherein
the first data includes video recording data relating to the interview between the first interview organizer and the interviewee of the first interview organizer, and
the second data includes video recording data relating to the interview between the second interview organizer and the interviewee of the second interview organizer.

10. The information processing system according to claim 7, wherein
the first data includes screen operation data during the interview between the first interview organizer and the interviewee of the first interview organizer, and
the second data includes screen operation data during the interview between the second interview organizer and the interviewee of the second interview organizer.

11. An information processing system comprising
a control unit, wherein
the control unit:
connects multiple users to an interview over the Internet;
receives voices of the multiple users during the interview; and
outputs, when a combination of keywords being set is detected from the received voices, material relating to the combination of keywords, in a manner comprehensible to at least one of the multiple users.

12. The information processing system according to claim 11, wherein
the control unit displays, in response to detection of the combination of keywords, the material relating to the combination of keywords on a screen during the interview.

13. The information processing system according to claim 11, wherein
the control unit performs voice recognition on the received voices, generates text data, and displays, in response to detection of the combination of keywords being set in the generated text data, the material relating to the combination of keywords, on a screen during the interview.

14. The information processing system according to claim 11, wherein
the control unit sets the combination of keywords by storing the combination of keywords in a storage area.

15. The information processing system according to claim 14, wherein
the control unit stores the combination of keywords and the material in association with each other in the storage area.

16. The information processing system according to claim 11, wherein
the multiple users include an interview organizer side user and an interviewee side user, and
the control unit controls, according to the combination of keywords, whether to display the material relating to the combination of keywords on an interview organizer side screen during the interview or on an interviewee side screen during the interview.

17. The information processing system according to claim 16, wherein
the control unit controls, according to the combination of keywords, whether to display the material relating to the combination of keywords on the interview organizer side screen during the interview or on the interviewee side screen during the interview, or on both the interview organizer side screen and the interviewee side screen during the interview.

18. The information processing system according to claim 11, wherein
the multiple users include an interview organizer side user and an interviewee side user, and
the control unit changes the material to be displayed on the screen during the interview depending on the combination of keywords, and information indicating whether the combination of keywords is included in a voice of the interview organizer side or in a voice of the interviewee side.

19. The information processing system according to claim 11, wherein
the multiple users include an interview organizer side user and an interviewee side user, and
the control unit controls whether to display the material relating to the combination of keywords on an interview organizer side screen or on an interviewee side screen, depending on the combination of keywords, and information indicating whether the combination of keywords is included in a voice of the interview organizer side or in a voice of the interviewee side.

20. The information processing system according to claim 19, wherein
the control unit controls whether to display the material relating to the combination of keywords on the interview organizer side screen, on the interviewee side screen, or on both the interview organizer side screen and the interviewee side screen, depending on the combination of keywords, and information indicating whether the combination of keywords is included in a voice of the interview organizer side or in a voice of the interviewee side.
